(19) United States
(12) Patent Application Publication
(10) Pub. No.: US 2010/0161235 A1
(43) Pub. Date: Jun. 24, 2010

(54) Imaging of multishot seismic data

(76) Inventor: Luc T. Ikelle, Bryan, TX (US)

Correspondence Address: Oppedahl Patent Law Firm LLC, P O Box 5940, Dillon, CO, 80435-5940, US

(21) Appl. No.: 12/089,573

(22) PCT Filed: Dec. 17, 2007
(86) PCT No.: PCT/US07/87817

§ 371 Date: Apr. 8, 2008

Related U.S. Application Data
(60) Provisional application No. 60/894,182, filed on Mar. 9, 2007.
(60) Provisional application No. 60/981,112, filed on Oct. 19, 2007.
(60) Provisional application No. 60/894,343, filed on Mar. 12, 2007.
(60) Provisional application No. 60/894,685, filed on Mar. 14, 2007.

(51) Int. Cl. G01V 1/30; G06F 19/00

(52) U.S. Cl. 702/17

(57) ABSTRACT

We here disclose methods of imaging multishot data without decoding. The end products of seismic data acquisition and processing are images of the subsurface. When seismic data are acquired based on the concept of multishooting (i.e., several seismic sources are exploited simultaneously or near simultaneously and the resulting pressure changes or ground motions are recorded simultaneously there are two possible ways to obtain images of the subsurface. One way consists of decoding multishot data before imaging them that is the multishot data are first converted to a new dataset corresponding to the standard acquisition technique in which one single shot at a time is generated and acquired and then second imaging algorithms are applied to the new dataset. Actually all seismic data processing packages available today require that multishot data be decoded before imaging them because they all assume that data have been collected sequentially.

### CROSS-REFERENCE TO RELATED APPLICATIONS

This application claims the benefit of U.S. application No. 60/981,112 filed Oct. 19, 2007, and of U.S. application 60/894,182 filed on Mar. 9, 2007, and of U.S. application 60/894,343 filed Mar. 12, 2007, and of U.S. application 60/894,685 filed on Mar. 14, 2007, each of which is hereby incorporated by reference for all purposes.

### BACKGROUND

The embodiment of this application relates to U.S. Pat. No. 6,327,537B1.

The preferred embodiment of this application also relates to Ober et al. (U.S. Pat. No. 6,021,094) that describes a method of migrating seismic records that retains the information in the seismic records and allows migration with significant reductions in computing cost. This invention involves the phase encoding of seismic records and then combining these encoded seismic records before migration. In other words this method combines recorded single shot gathers into multishot gathers in order to reduce the computational cost of migration. However, this method:
(i) does not modify migration operators for multishot data processing;
(ii) does not include the imaging of recorded multishoot data;
(iii) does not include the velocity estimation of multishot data; and
(iv) does not include the multiple attenuation of multishot data.

The preferred embodiment of this application also relates to Zhou et al. (U.S. Pat. No. 6,317,695) that describes a method for migrating seismic data in which seismic traces recorded by a plurality of receivers are separated into offsets bands according to the offsets of the traces. The data in each offset band are then migrated according to a downward continuation method. However, this method:
(i) does not modify migration operators for multishot data processing;
(ii) does not include the imaging of recorded multishot data;
(iii) does not include the velocity estimation of multishot data; and
(iv) does not include the multiple attenuation of multishot data.

The difference between this application and the prior art is that we are not decoding data as required with the methods described in this application.

### SUMMARY

The reconstruction of subsurface images from real multishot data is similar to a very well known challenging problem in auditory perception, the cocktail-party problem. This problem can be stated as follows: Imagine I people speaking simultaneously in a room containing two microphones. The output of each microphone is the mixture of I voice signals just as multishot data are a mixture of data generated by single sources. In signal processing, the I voice signals are the sources and the microphones' recordings are the signal mixtures. To avoid any confusion between seismic sources and the sources in the cocktail party problem we simply continue to call the latter voice signals. Solving the cocktail-party problem consists of reconstructing from the signal mixture the voice signal emanating from each person. We can see that solving this problem is quite similar to decoding multishot data in the cocktail party problem the voice signals correspond to single shot data and a signal mixture corresponds to one sweep of multishot data.

If the two microphones in the cocktail-party problem represent human ears (specifically the organs of hearing), we end up with the cocktail party problem as first formulated by Colin Cherry and his co-workers [Cherry (1953), (1957), (1961); Cherry and Taylor (1954); Cherry and Sayers (1956), (1959) and Sayers and Cherry (1957)]. In his paper Cherry wrote: “One of our most important faculties is our ability to listen to and follow one speaker in the presence of others. This is such a common experience that we may take it for granted. No machine has been constructed to do just this, to filter out one conversation from a number jumbled together.” In other words the cocktail party problem refers to the remarkable but not always perfect human ability to selectively understand a single speaker in a noisy environment. The noise is primarily generated by the other speakers attending the cocktail party. If the cocktail party is taking place in a room, the noise will also include reverberations. The human brain has the ability to solve the cocktail party problem with relative ease. Actually this ability does not correspond to the human brains ability to solve the pure decoding problem as we have formulated it so far. Neurobiologists have established that the ability of the human brain to solve the cocktail party problem is the result of three processes which are performed in the auditory system:(i) segmentation; (ii) selective attention; and (iii) switching.

Segmentation is essentially a spatial-filtering operation in which only sounds coming from the same location are captured, and those originating in different directions are ignored or filtered out. The selective attention process refers to the ability of the listener to focus attention on one voice signal while blocking attention to irrelevant signals. This process also characterizes the human ability to detect a specific voice signal in a background of noise. The switching process involves the ability of the human brain to switch attention from one channel to another. Let us add the fact that the nature of sound perception also plays a key role in the human brain's ability to solve the cocktail party problem especially through phonemic recognition and the redundancy of voice signals.

In regard to multishooting one of the lessons we can learn from this description of how the human brain goes about solving the cocktail party problem is that we need to develop a seismic-processing system capable of interpreting multishot data rather than just relying on a pure signal separation system as we have posed the problem so far in our decoding approach. In other words, solving the seismic multishooting problem comes down to directly imaging multishot data without decoding them. Such an approach takes advantage, for example, of focusing and defocusing (see Ikelle and Amundsen, 2005), which are among the basic operations in seismic data processing. It also allows us to take advantage of the huge redundancies built into seismic data acquisition. For these reason, we present here an invention of algorithms for imaging multishot seismic data without decoding them.

Beside input output and plotting algorithms seismic data-processing packages generally have more than 30 algorithms. A significant number of them can be used for the processing of multishot data without modification such as up/down separation algorithms deconvolution and designature algorithms, swell noise attenuation algorithms and interference noise attenuation algorithms. However, all the modern processing algorithms which requires sorting of data in receiver gathers CMP gathers, and offset gathers must be reformulated because such operations are not possible on multishot data without decoding them. The modern algorithms of multiple attenuation velocity estimation migration and inversion for elastic parameters are the typical examples of algorithms that require a reformulation for imaging multishot data without decoding them. So this invention presents new forms of the most up to date algorithms of multiple attenuation, velocity estimation, migration, and inversion of multishot data without decoding them. These modifications are based on the fact that these algorithms contain correlation operations which allow them to correlate a mathematical operator with one specific event of the data at a time while ignoring the others. For cases in which the correlation involves two datasets as in multiple attenuation algorithms one correlation at a time involving one event of one dataset with another event of the other dataset is performed while ignoring the other correlations. So for the imaging of multishot data without decoding we have encoded the source signatures with time delays such that differences in lag time facilitate the detection of the desired correlations in this algorithm.

For multiple attenuation algorithms we also describe a second solution. This solution consists of collecting data twice at different sea levels: one at low tide and another at high tide (see FIG. 2). During the two experiments we must keep the depth of the source relatively constant with respect to the sea floor so that primary reflections resulting from these two experiments will be almost the same (as illustrated in FIG. 2). The problem of attenuating multiples can then be addressed as another cocktail-party problem using the statistical decoding techniques. In this case the two microphones correspond to low- and high-tide experiments and primaries and multiples are components that are mixed in these two experiments. This solution is limited to seas in which the difference between high and low tides is 5 m or more.

### FIGURES

FIG. 1 illustrates two possible ways routes of processing multishot data. Route 1 consists of directly processing the multishot data without decoding whereas, Route 2 requires that multishot data be decoded before imaging them.

FIG. 2 is an illustration of two low and high tide experiments, (a) one under low tide conditions and (b) the other under high tide conditions. During the two experiments the depth of the source (i.e., z₁) is kept relatively constant with the sea floor so that the primary events and internal multiples resulting from the two experiments are almost identical. However, the free-surface reflections [in doted lines in (b)] are different in the two experiments.

FIG. 3 is an illustration of the construct of free surface multiples and ghosts for the cases in which (a) the data contain the direct wave and (b) data does not contain the direct wave.

FIG. 4 is

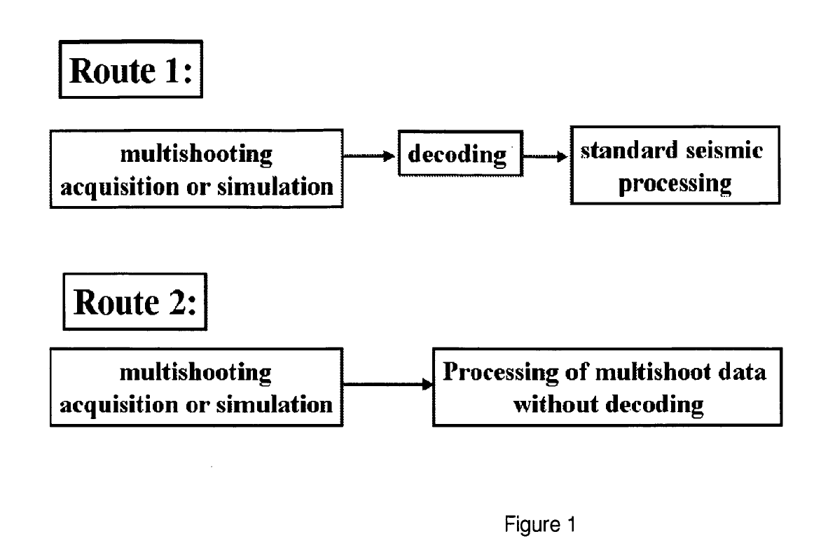

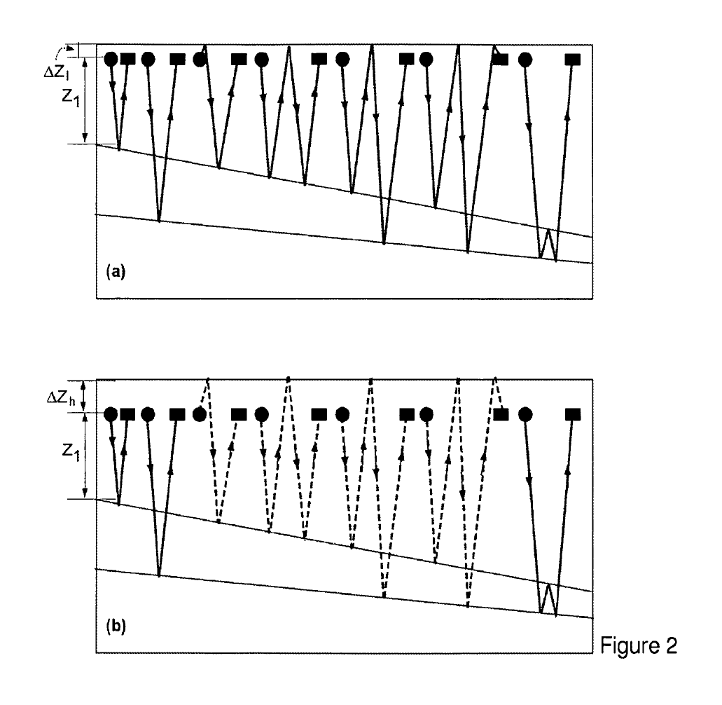

(a) an illustration of events predicted by the multidimensional convolution of the portion of data located above the BMG bottom multiple generator reflection and the entire raw data (i.e., the multidimensional convolution of V₀^{α} by Φ₀^{a}. The BMG reflectors in this picture are indicated by the dotted lines. Notice that all free-surface multiples whose first bounce is located above the primary associated with the BMG reflector are predicted by this convolution operator. Moreover, each event is predicted only once. The first step our linear solution is designed to attenuate events predicted by this convolution;

(b) an illustration of events predicted by the multidimensional convolution of a portion of the result of the first step of our linear solution located below the BMG reflection and the portion of raw data located above the BMG reflector (i.e., the multidimensional convolution of V_{pα}^{b} by Φ₀^{a}). Now all free surface multiples whose first bounce is located below the primary associated with the BMG reflector are predicted by this convolution operator. The second step of our linear solution is designed to attenuate events predicted by this convolution; and

(c) an illustration of events which are not modeled by our solution and therefore not attenuated by it.

FIG. 5 is an illustration of multishot positions. Snm indicates the nth single-shot point associated with the mth multishooting position.

FIG. 6 illustrates mixture vectors and source vectors in mixture space.

FIG. 7 illustrates the key steps in an algorithm for predicting receiver ghosts of primaries only.

FIG. 8 illustrates the up/down based demultiple for multishot data that can be described in three steps.

FIG. 9 illustrates the algorithm for attenuation of multishoot data—1D model.

FIG. 10 illustrates an algorithm of an alternative implementation of a ID-model based on the concept BMG.

FIG. 11 illustrates an algorithm of an alternative way of to a linear solution in (13)-(16) in which the output in the receiver ghosts of primaries instead of primaries themselves.

FIG. 12 illustrates an algorithm of multiple attenuation of multishot data by using F-K filtering techniques.

FIG. 13 illustrates an algorithm of Kirchhoff multiple attenuation of multishot data with an undetermined ICA model.

FIG. 14 illustrates an algorithm of Kirchhoff multiple attenuation of multishot data using a noisy ICA model.

FIG. 15 illustrates a multiple attenuation algorithm for multishot data and for single shot data.

FIG. 16 illustrates an algorithm for the demultiple based on the convolutive mixture model.

FIG. 17 illustrates an algorithm for multishot data or single-shot data.

FIG. 18 illustrates an algorithm for velocity migration analysis of multishot data.

FIG. 19 illustrates algorithm of the global approach involves working with the entire model.

FIG. 20 illustrates the ICASEIS algorithm.

### DETAILED DESCRIPTION

1. A Brief Review of Kirchhoff-Based Free-Surface Multiple Attenuation

1.1 Nonlinear Formulation

As in most parts of this document formulation in this section can be extended to all marine acquisition geometries. However, we will focus on towed streamer acquisition as most of our numerical examples here correspond to towed streamer acquisition geometry.

Let Φ₀={P₀, V₀} be the two component vector of towed streamer data where P₀ represents the pressure and V₀ represents the vertical component of the particle velocity. The inverse Kirchhoff scattering series for attenuating free-surface reflections from seismic data in the F-X domain can be written as follows:

Φ_{P}(xᵣ,yᵣω,xₛ,yₛ)=Φ₀(xᵣyᵣ,ω,xₛ,yₛ)+α(ω)Φ₁(xᵣ,yᵣ,ω,xₛ,yₛ)+α²(ω)Φ₂(xᵣ,yᵣ,ω,xₛ,yₛ)+ . . . , (1)

where Φ_{P} represent the data without free-surface reflections and α(ω)=1/s(ω) the inverse source signature with s(ω) being the source signature. The fields Φ₁, Φ₂, etc., are given by

Φₙ(xᵣ,yᵣ,ω,xₛ,y₂)=∫_{-∞}^{∞}dx∫_{-∞}^{∞}dyΦₙ₋₁(xᵣ,yᵣ,ω,x,y)×V₀^{nd}(x,y,ω,xₛ,yₛ), (2)

where V₀^{nd}(x,y,ω,xₛ,yₛ) is the vertical component of the particle velocity without the direct wave. Basically, each of the two components of towed streamer data constitutes a separate series. The first term of the scattering series, Φ₀, is the actual data the second term, Φ₁, is computed as a multidimensional convolution of the data Φ₀ by the vertical component of particle velocity data which we denote V₀ aims at removing events which correspond to one bounce at the sea surface; the next term, Φ₂ is computed as a multidimensional convolution of the data Φ₁ by streamer data V₀, aims at removing events which correspond to two bounces at the sea surface; and so on. In summary the terms Φ₁, Φ₂, Φ₃, etc., allow us to predict free surface multiples whereas the inverse source α(ω) a permits us to eliminate predicted multiples from the data Φ₀. Notice that the application of this series does not require any knowledge of the subsurface.

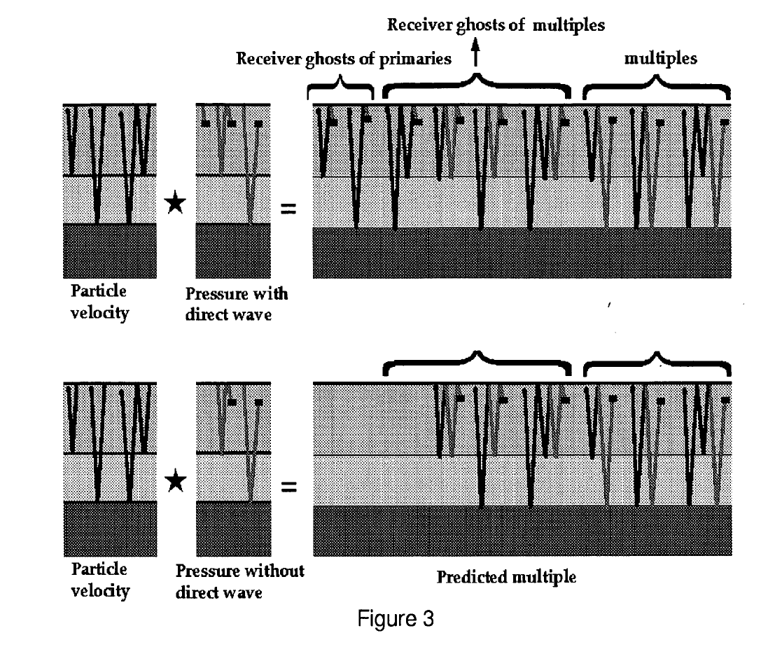

As illustrated in FIG. 3 the fields Φ₁, Φ₂, etc., predict receiver ghosts of primaries, free surface multiples and the ghosts of free surface multiples if the data Φ₀ contain direct waves. In these circumstances the series allows us to remove receiver ghosts of primaries free surface multiples and the ghosts of free surface multiples from the data. However, if Φ₀ does not contain direct waves, the fields Φ₁, Φ₂, etc., predict only free-surface multiples and the ghosts of free-surface multiples. Hence the out of the series in (1) consists of primaries and all the ghosts of primaries. In most seismic applications, the series in (1) is used in the latter form.

In most towed seismic acquisitions we still record only pressure field P₀ alone. So the fact that each component of Φ₀ can be demultipled separately is quite handy. In other words the series (1) can be written in this case as follows:

P_{P}(xᵣ,yᵣ,ω,xₛ,yₛ)=P₀(xᵣ,yᵣ,ω,xₛ,yₛ)+α(ω)P₁(xᵣ,yᵣ,ω,xₛ,yₛ)+α²(ω)P₂(xᵣ,yᵣ,ω,xₛ,yₛ)+ . . . , (3)

where Pₚ represents the data without free-surface reflection and the fields P₁, P₂ etc., are given by

Pₙ(xᵣ,yᵣ,ω,xₛ,yₛ)=∫_{-∞}^{∞}dx∫_{-∞}^{∞}dy Pₙ₋₁(xᵣ,yᵣ,ω,x,y)+V₀^{nd)}(x,y,ω,xₛ,yₛ). (4)

However, we still need to know the vertical component of the particle velocity without the direct wave. Basically each of the two components of towed streamer data constitutes a separate series. We can compute the vertical component of the particle velocity data from the pressure data as follows:

$${V}_{0} ( {x}_{r} , {y}_{r} , ω , {x}_{s} , {y}_{s} ) = \frac{1}{Z} {\int }_{- ∞}^{+ ∞} {\int }_{- ∞}^{+ ∞} d {k}_{x} d {k}_{y} \sqrt{1 - \frac{{{c}^{2} [ {k}_{x}^{2} + {k}_{y}^{2} ]}^{2}}{{ω}^{2}}} \times {P}_{0} ( {k}_{x} , {k}_{y} , ω , {x}_{s} , {y}_{s} ) exp \{ i ( {k}_{x} {x}_{r} + {k}_{y} {y}_{r} ) \} , \qquad ( 5 )$$

where P₀(kₓ,k_{y},ω,xₛ,yₛ) is the Fourier transform of the actual pressure data P₀(kₓ,k_{y},ω,xₛ,yₛ) with respect to x and y, kₓ and k_{y} are the wavenumbers associated with x and y, ω denotes temporal frequency, xᵣ and xₛ denote receiver and source positions respectively Z is the acoustic impedance of the water, and c is the velocity of the water. Strictly speaking, this formula is valid only when the receiver-ghost effects can be treated as part of the source signature.

1.2 Subtraction of Predicted Multiples from the Data

Let us now turn to the problem of subtracting predicted multiples from the data that is the problem of estimating the inverse source signature α(ω). One approach proposed by Ikelle et al. (1997) consists of using the early-arrival part of the data, which contains only primaries and first-order multiples. In the window of the data the series in (1) reduces to

Φ_{P}(xᵣ,yᵣ,xₛ,yₛ,ω)=Φ₀(xᵣ,yᵣ,xₛ,yₛ,ω)+α(ω)Φ₁(xₛ,yₛ,xᵣ,yᵣ,ω). (6)

We can now estimate α(ω) as a linear inverse problem using the least square criterion, for example. So to obtain α(ω), we can minimize

S(α)=∥Φ_{P}⁽ⁱ⁾∥²+∥α∥², (7)

where

∥Φ_{P}⁽ⁱ⁾∥²=∫dxᵣ∫dyᵣ∫dxₛ∫dyₛ∫dωΦ_{P}⁽ⁱ⁾(xᵣ,yᵣ,xₛ,yₛ,ω) (8)

and

∥α∥²=σ²∫dω∫dω′ A(ω) W_{A}⁻¹(ω,ω′)A*(ω′). (9)

The asterisk denotes a complex conjugate, Φ₀⁽ⁱ⁾ represents one component of the data and Φ₁⁽ⁱ⁾ represents one component of the field of free surface multiples, Φ₁. The weighting function W_{A}(ω,ω′) describes the a priori information on the source. The term ∥α∥² is introduced to guarantee the stability of the solution. To simplify subsequent inversion formulae, we have also introduced the constant σ² in the definition of ∥α∥² .

The minimization problem [equation (7)] gives the following analytical solution:

$$\begin{matrix}A ( ω ) = - \frac{\begin{matrix}\int d {ω}^{′} \int d {x}_{r} \int d {y}_{r} \int d {x}_{s} \int d {y}_{s} {W}_{A} ( ω , {ω}^{′} ) \\ N ( {x}_{r} , {y}_{r} , {x}_{s} , {y}_{s} , {ω}^{′} )\end{matrix}}{\begin{matrix}{σ}^{2} + \int d {ω}^{′} \int d {x}_{r} \int d {y}_{r} \int d {x}_{s} \int d {y}_{s} {W}_{A} ( ω , {ω}^{′} ) \\ Q ( {x}_{r} , {y}_{r} , {x}_{s} , {y}_{s} , {ω}^{′} )\end{matrix}} , \\ where & ( 10 ) \\ N ( {x}_{r} , {y}_{r} , {x}_{s} , {y}_{s} , ω ) = {{Φ}_{0}^{( i )} ( {x}_{r} , {y}_{r} , {x}_{s} , {y}_{s} , ω ) [ {\tilde{Φ}}_{1}^{( i )} ]}^{*} ( {x}_{r} , {y}_{r} , {x}_{s} , {y}_{s} , ω ) \\ and & ( 11 ) \\ Q ( {x}_{r} , {y}_{r} , {x}_{s} , {y}_{s} , ω ) = {{\tilde{Φ}}_{1}^{( i )} ( {x}_{r} , {y}_{r} , {x}_{s} , {y}_{s} , ω ) [ {\tilde{Φ}}_{1}^{( i )} ]}^{*} ( {x}_{r} , {y}_{r} , {x}_{s} , {y}_{s} , ω ) & ( 12 )\end{matrix}$$

We first note that N(xᵣ,yᵣ,xₛ,yₛ,ω) is a crosscorrelation between the data and the predicted free surface multiples whereas Q(xᵣ,yᵣ,xₛ,yₛ,ω) an autocorrelation of the predicted multiples. For the source estimation we are interested only in the cross correlation between the actual free surface multiples in the data and the predicted free surface multiples. So the weighting functions, W_{D} and W_{A}, are chosen to window these events which are generally near the zero time lag and to reduce the other types of correlations to zero.

1.3 Linear Inverse Solution: the BMG Approach

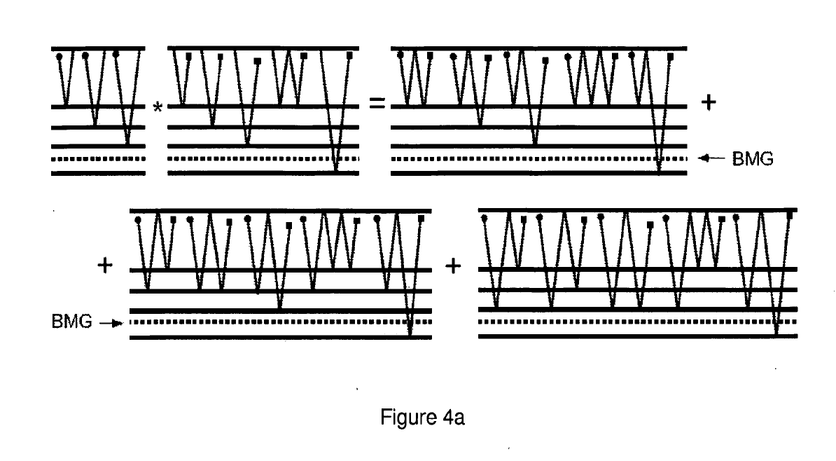

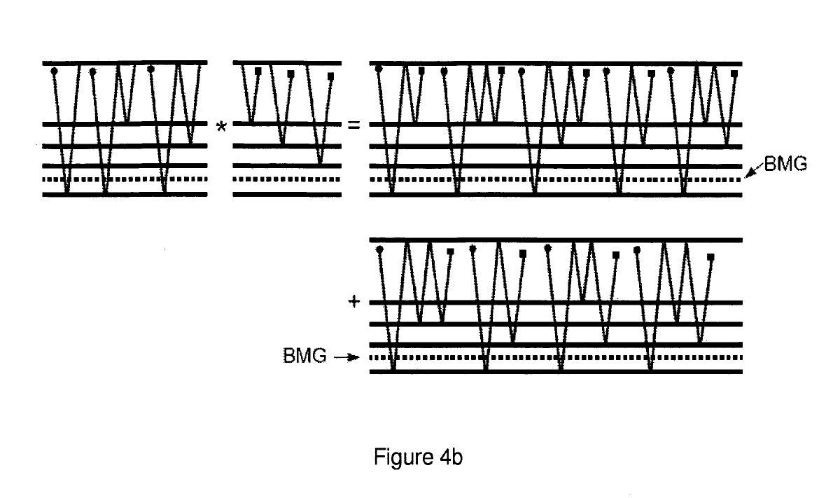

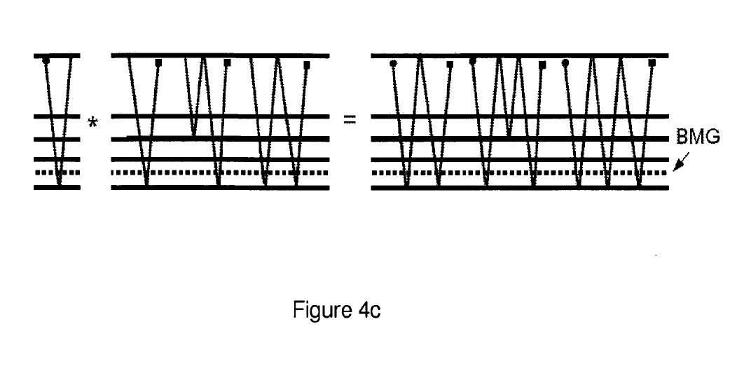

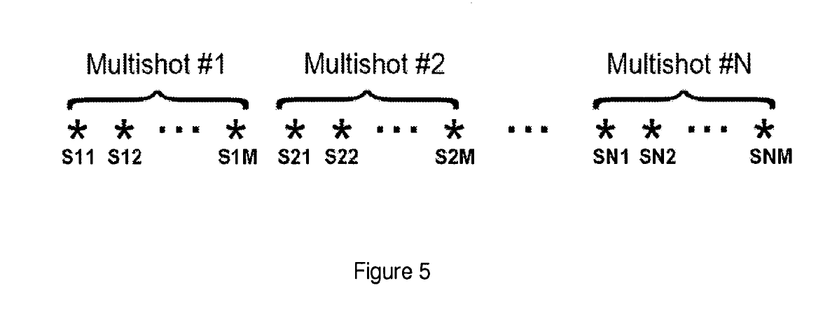

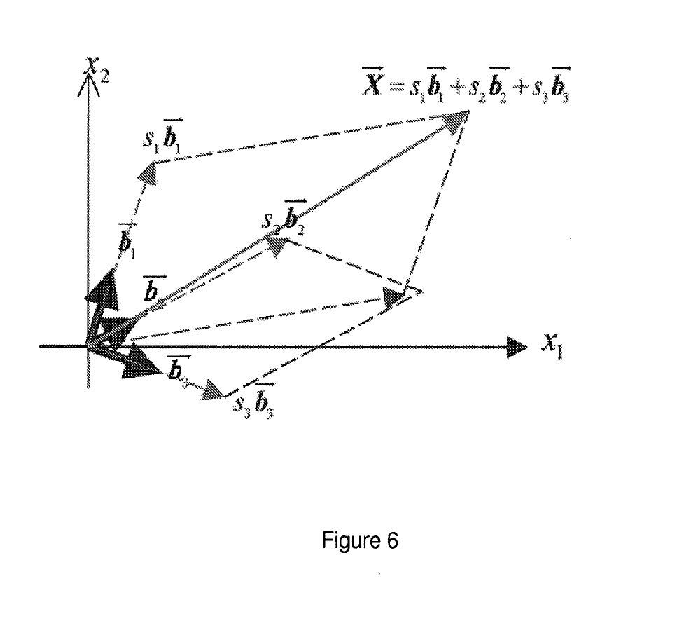

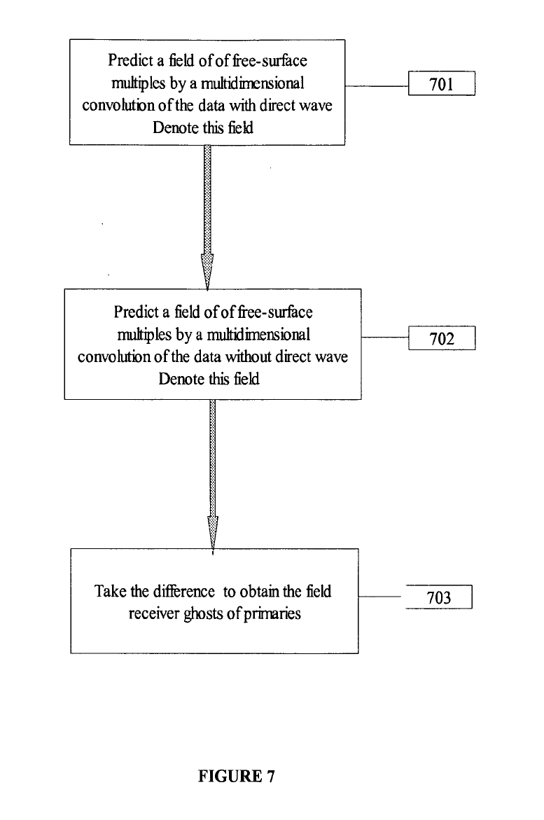

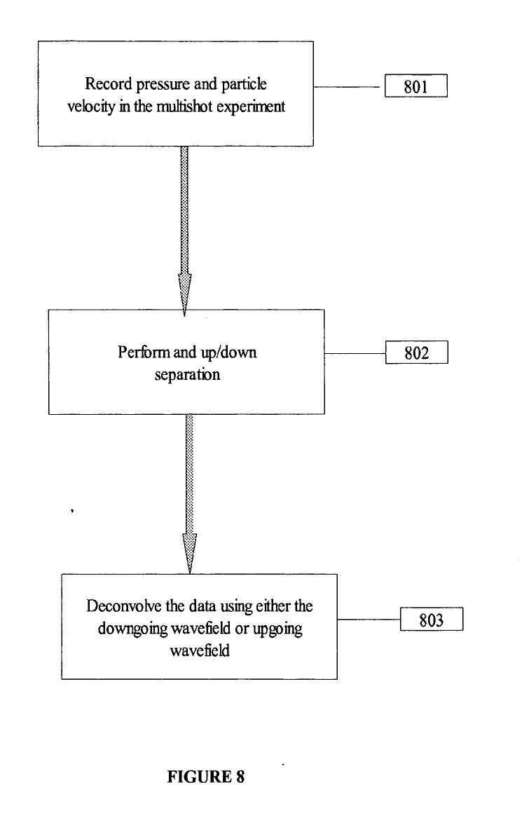

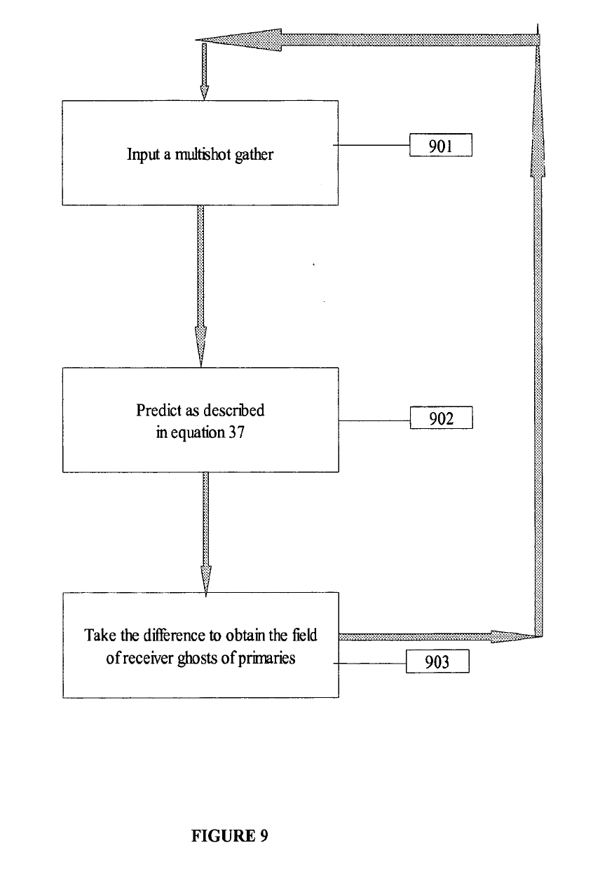

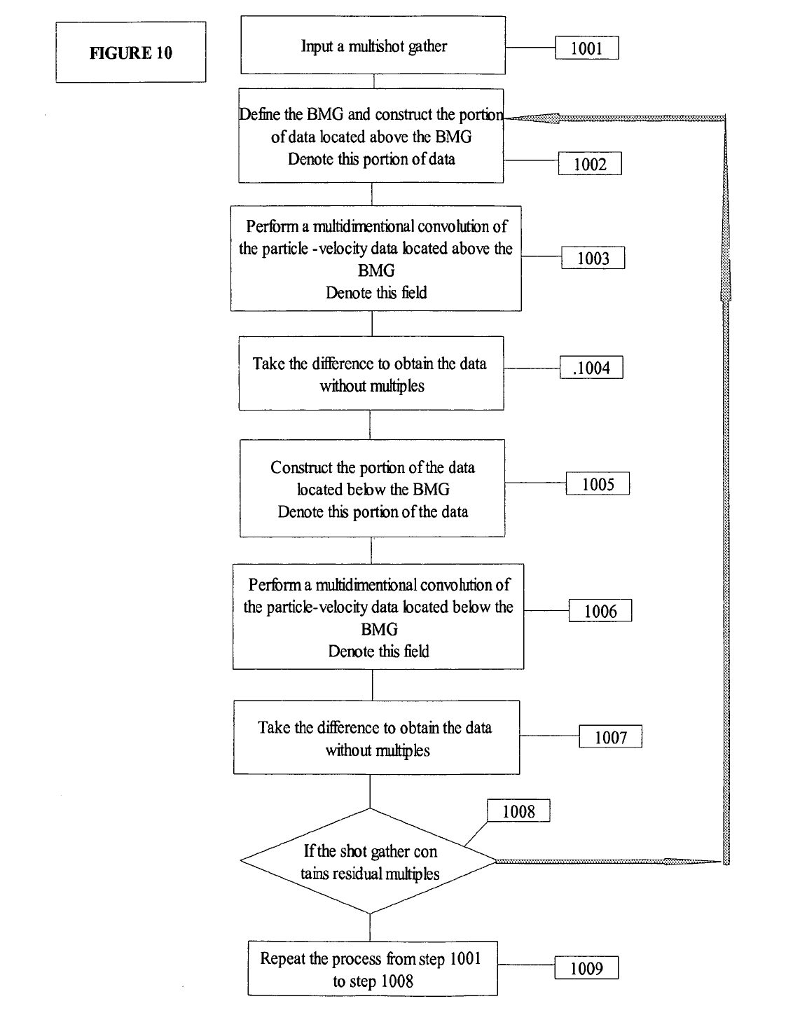

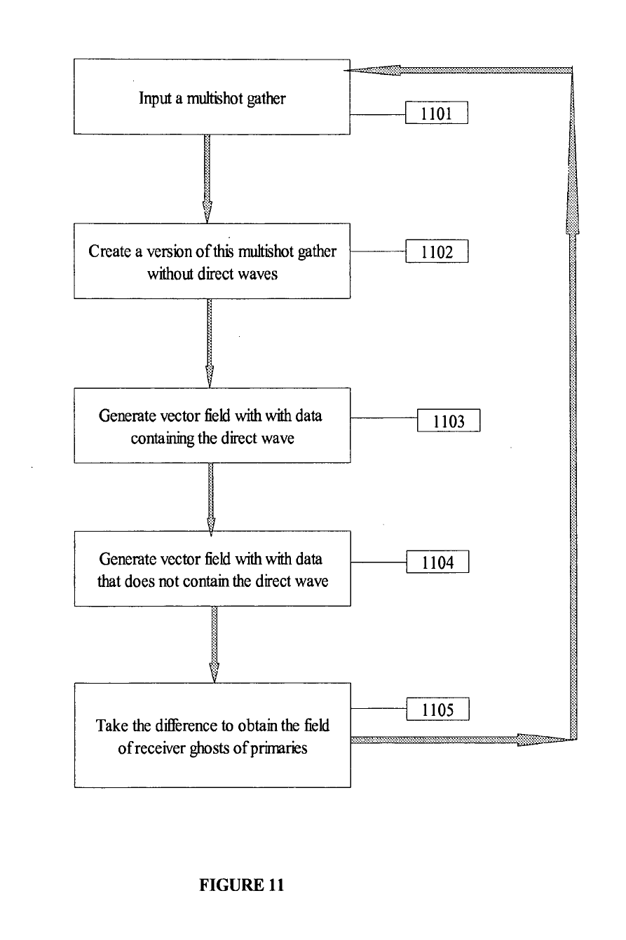

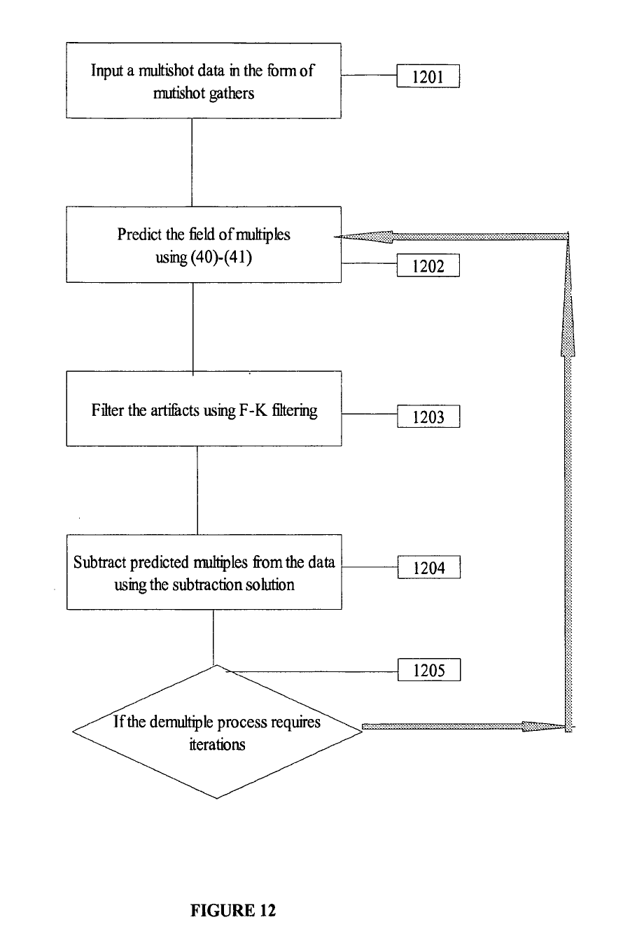

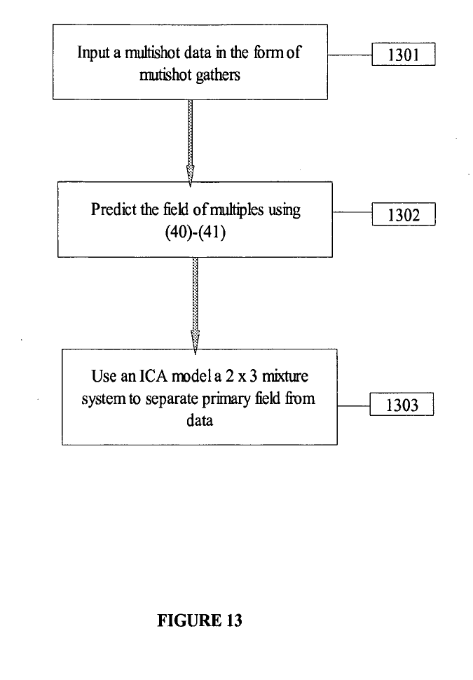

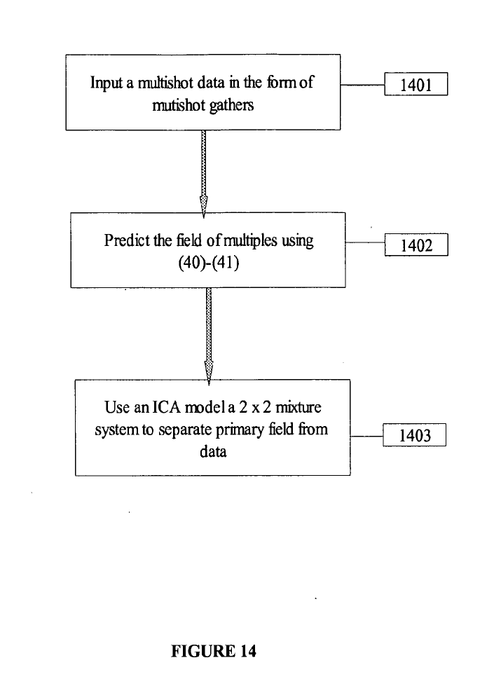

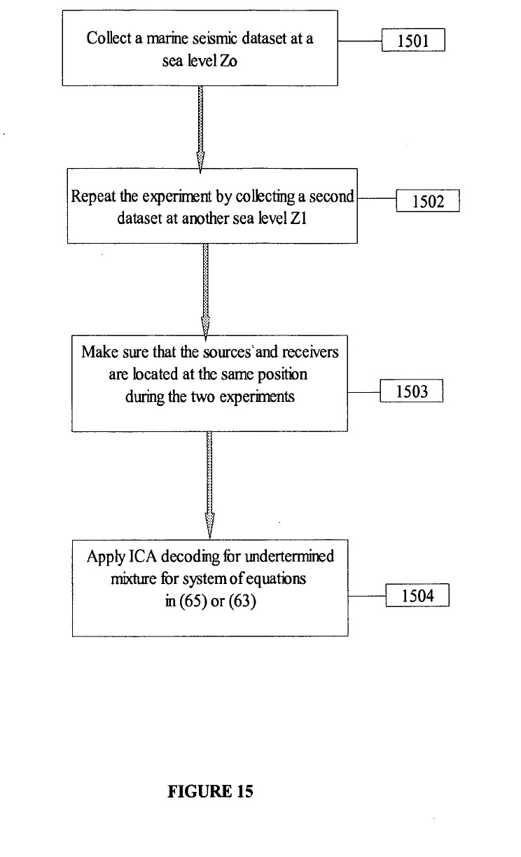

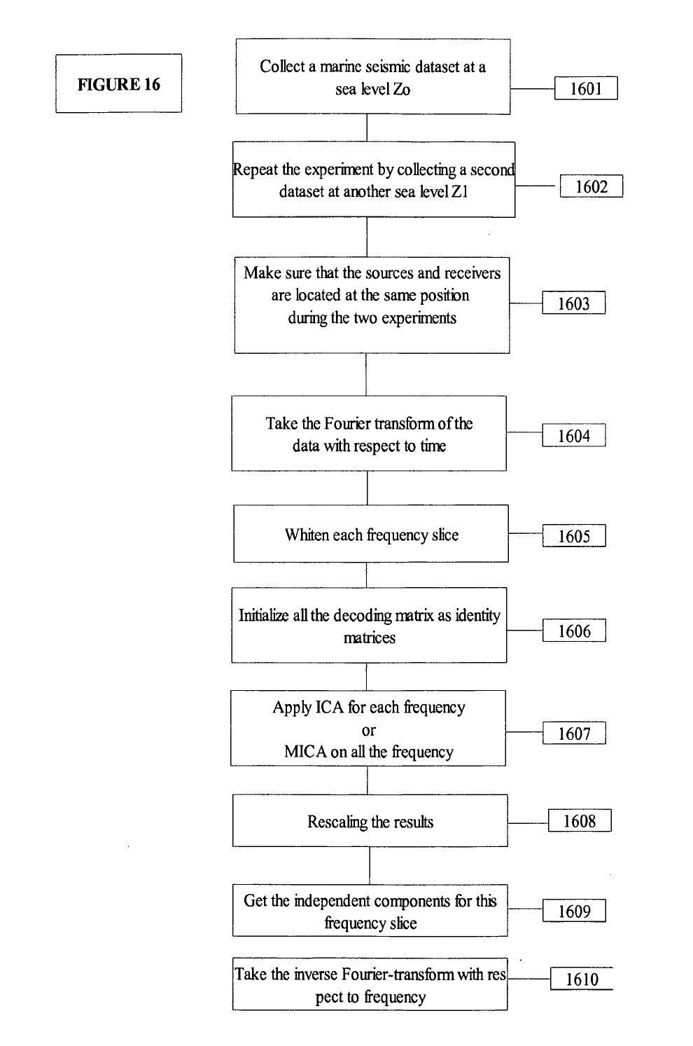

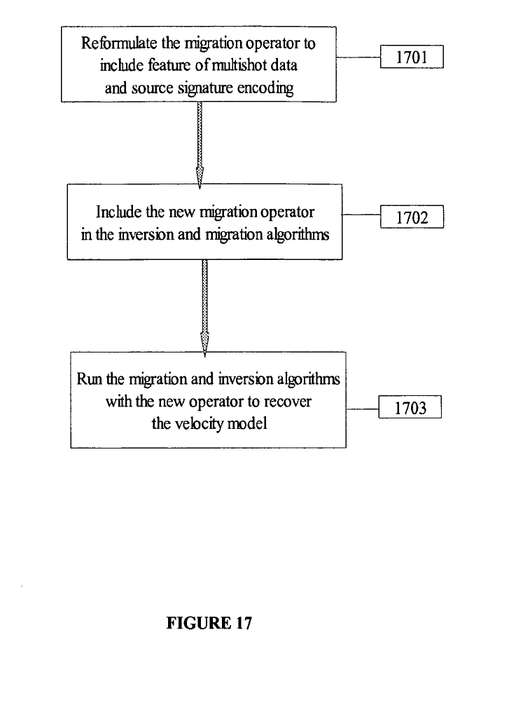

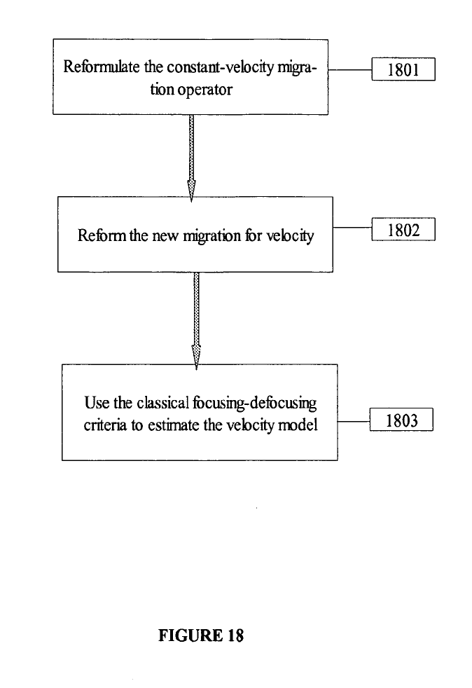

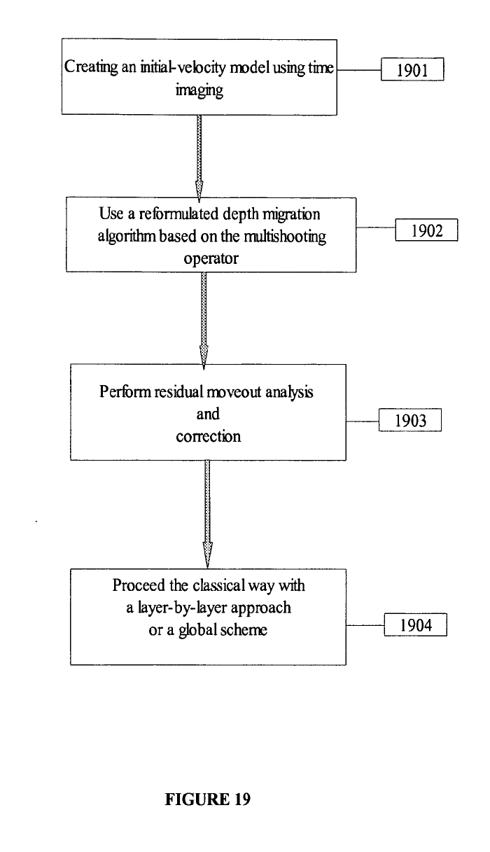

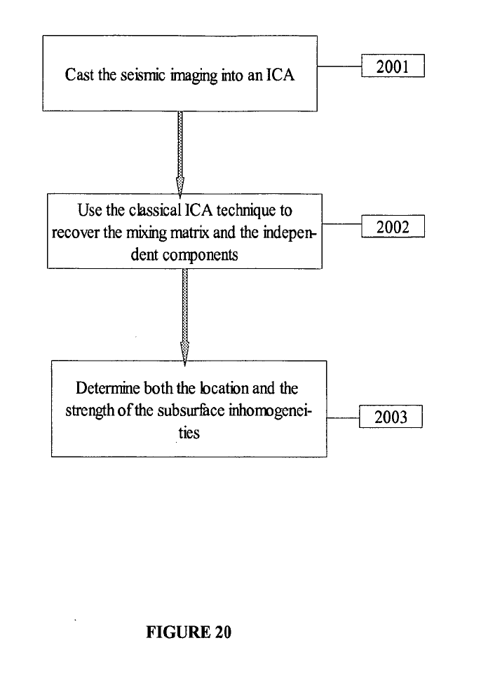

As described, above the numerical implementation of the series in (1) consists of first computing the terms Φ₁, Φ₂, Φ₃, etc. Second we scale them by an appropriate inverse of the source signature, α, then we subtract them from the data. The computation of the terms etc., Φ₁, Φ₂, Φ₃, etc., is the most expensive part of this algorithm in data storage as well as in computation time. Significant efforts have been made in the last decade to reduce the number of terms of the series that one needs to compute in practice. One approach consists of recognizing that Φ₁ actually predicts all ghosts and free surface multiples including the higher order free surfaces and their ghosts that we need to remove from the data. Moreover, it predicts them accurately. However, some events are predicted several times by Φ₁. That is why the other terms of the series are needed to effectively remove multiples. As illustrated in FIG. 4, for example, the first-order multiple is predicted only once and by term Φ₁ only. However, the second order multiple is predicted twice by term Φ₁ and once by term Φ₂; therefore we need Φ₂ in addition to Φ₁ to simultaneously attenuate first- and second-order multiples. The third order multiple is predicted three times by Φ₁, twice by Φ₂, and once by Φ₃; therefore we need Φ₂ and Φ₃ in addition to Φ₁ to simultaneously attenuate all the first-, second-, and third-order multiples. So if we can modify the computation of Φ₁ so that each multiple can be predicted only once, the demultiple process can be conned to the first two terms of the series in (1). One way of doing so is through the concept of the bottom multiple generator (BMG) reflector.

The BMG reflector is a hypothetical reflector whose primary reflection associated with it arrives at the same time as the first-water bottom multiple. The reason for introducing this hypothetical reflector is that it allows us to define a portion of data which contain only primaries. The multidimensional convolution of the portion of data containing only primaries with the actual data is one way of avoiding predicting some multiple events several times and hence of eliminating the nonlinearity aspect of the problem of the attenuation of free surface multiples in towed streamer data as we will see later.

Let us denote by Φ₀^{α}={P₀^{α},V₀^{α}} the portion of towed streamer data located above the hypothetical primary associated with the BMG reflector. The first step of our linear solution is to replace (1) by

Φₚₐ=Φ₀+αΦ₁ₐ, (13)

with

Φ_{1α}′(xᵣ,yᵣ,zᵣ,ω,xₛ,yₛ,zₛ)=∫_{-∞}^{∞}dx∫_{-∞}^{∞}dyΦ₀^{(nd)}(xᵣ,yᵣ,zᵣ,ω,x,y,zₛ)×V₀^{(nd)}(x,y,z,ω,xₛ,yₛ,zₛ). (14)

Φ_{1α}′(xᵣ,yᵣ,zᵣ,ω,xₛ,yₛ,zₛ)=∫_{-∞}^{∞}dx∫_{-∞}^{∞}dyΦ₀^{(nd)}(xᵣ,yᵣ,zᵣ,ω,x,y,zₛ)×V₀^{(nd)}(x,y,z,ω,xₛ,yₛ,zₛ). (15)

where Φ₁ₐ a is computed as a multidimensional convolution of V₀^{a} by Φ₀. Illustrations of events created by this multidimensional convolution are illustrated in FIG. 4a. Notice that the term Φ₁ₐ predicts all orders of free surface multiples (although only first-order and second-order multiples are shown in FIG. 4a due to limited space and it predicts each event only once. But Φ₁ₐdoes not predict free-surface multiples whose first bounce is located below the primary associated with the BMG reflector that is why we need a second step.

Let us denote by V_{pα}^{b} the portion of V_{pα} (i.e.,the component of Φ₁ₐ corresponding to the particle velocity located below the hypothetical primary associated with the BMG reflector. The second step of our linear solution can be expressed as follows:

Φ_{pb}=Φₚₐ+αΦ_{1b}, (16)

where is computed as a multidimensional convolution of V_{pα}^{b} by Φ₀^{a}. Illustrations of events created by this multidimensional convolution are illustrated in FIG. 4a. Notice that the term Φ_{1b} predicts free surface multiples whose first bounce is located below the primary associated with the BMG reflector without again predicting the events predicted by Φ₁ₐ and removed in the first step in (2).

Notice also that the two step linear solution that we have just described does not predict free surface multiples whose first and last bounces in the subsurface are located below the BMG reflector. Examples of these types of free-surface multiples are given in FIG. 4c. Fortunately, these types of free-surface multiples are generally quite weak—as weak as internal multiples—especially in deeper water cases which are of prime interest to the modern E&P industry. For shallow water-cases we will discuss the issue of extending the depth of the BMG later.

For the source estimation the method described above applies here without any modification. Moreover, no truncation of the data to early arrivals is needed here because the relation between the data and the predicted multiples is linear all through the time length of the data.

2. Linear Inverse Solution Predicting Receiver Ghosts of Primaries Only: Algorithm #1.

The basic idea of this alternative linear solution is that Φ₁ allows us to predict free surface multiples and receiver ghosts as well as the receiver ghosts of primaries if recorded towed-streamer data contain direct-wave arrivals. However, if the direct wave arrivals are removed from the data, the new Φ₁ which we will denote Φ₁′, does not predict the receiver ghosts of primaries. So the difference between Φ₁ and Φ₁′ can be used to produce a vector field of towed-streamer data containing receiver ghosts of primaries only. In algorithmic terms the algorithm for predicting receiver ghosts of primaries can be described only in the following three steps:

(i) We compute the vector field Φ₁ of free surface multiples and ghosts as well as the receiver ghosts of primaries by combining the vertical particle velocity field, \hat{v}_{z}, with the recorded data, Φ₀:

Φ₁(xᵣ,yᵣ,zᵣ,ω,xₛ,yₛ,zₛ)=α(ω)∫_{-∞}^{∞}dx∫_{-∞}^{∞}dyΦ₀(xᵣ,yᵣ,xᵣ,ω,x,y,zᵣ)×\hat{V}₀(x,y,zᵣ,ω,xₛ,yₛ,zₛ). (17)

Notice that the data, Φ₀, used in this equation contain direct wave arrivals and that the source ghosts of primaries are predicted by (8). Also notice that V₀ does not contain direct wave arrivals.

(ii) We now compute the vector field of free-surface multiples, Φ₁′, and the source ghosts of free surface multiples:

Φ₁′(xᵣ,yᵣ,zᵣ,ω,xₛ,yₛ,zₛ)=α(ω)∫_{-∞}^{∞}dx∫_{-∞}^{∞}dyΦ₀^{(nd)}(xᵣ,yᵣ,xᵣ,ω,x,y,zᵣ)×\hat{V}₀(x,y,zᵣ,ω,xₛ,yₛ,zₛ). (18)

where Φ₀^{(ωd)}={p₀^{(ωd)},v₀^{(ωd)}} represents the recorded data in which the direct wave arrivals have been removed. Notice that Φ₁′ does not predict any ghosts of primaries or primaries themselves.

(iii) Finally we take the difference between Φ₁ and Φ₁′, i.e.,

Φ_{GP}(xₛ,xᵣ,ω)=Φ₁(xₛ,yᵣ,ω)−α(ω)Φ₁′(xₛ, xᵣ,ω), (19)

to obtain the field Φ_{GP}, which contains only receiver ghosts of primaries. Notice that we have introduced a scaling factor α in this subtraction to compensate for the fact that Φ₁ contains receiver ghosts of free surface multiples, which Φ₁′ does not contain. Because the receiver ghosts of free surface multiples in towed streamer data can be treated as free surface multiples with a different source signature, we need the scaling factor α to adjust the amplitudes of free-surface multiples contained in fields Φ₁ and Φ₁′. The difficulty of this implementation is the estimation of α. The substation described earlier does not apply here because α is a nonstationary function. However, we can use the adaptive noise cancellation described below to obtain Φ_{GP} by assuming that Φ₁′ is the reference noise and Φ₁ is the primary signal plus noise.

Our implementation also assumes that the output of IKSMA is receiver ghosts of primaries instead of the primaries themselves. Because primaries and receiver ghosts of primaries are almost indistinguishable in towed-streamer data the output of most present multiple attenuation algorithms is actually a combination of primaries and receiver ghosts of primaries yet this problem does not seem to affect imaging or amplitude analysis algorithms. So we expect that the effect of outputting receiver ghosts of primaries instead of primaries themselves will be insignificant in regard to imaging and amplitude analysis algorithms.

A canonical time-series-analysis problem is that of shaping filter estimation: given an input time series Φ₁′ and a desired time series Φ₁ we must compute a filter, a, that minimizes the difference between α*Φ₁′ and Φ₁. Optimal filter theory provides the classical solution to the problem by finding the filter that minimizes the difference in a least squared sense, i.e., minimizing

$${\sum }_{i} {\vert {\sum }_{j} {a}_{j} {b}_{i - j} - {d}_{i} \vert}^{2} , \qquad ( 20 )$$

where b corresponds to one of the component of Φ₁′ and d corresponds to one of the components of Φ₁′. With the notation that B is the matrix representing the convolution with time series b we can rewrite this desired minimization as a fitting goal,

Ba−d≈0 (21)

which leads us to the following system of normal equations for the optimal shaping filter:

B^{T}Ba=B^{T}d. (22)

Equation (22) implies that the optimal shaping filter, a, is given by the cross-correlation of b with d, filtered by the inverse of the auto correlation of b. The auto correlation matrix B^{T}B, has a Toeplitz structure that can be inverted rapidly by Levinson recursion.

For most problems we do not want the filter impulse responses to vary arbitrarily. We would rather consider only filters whose impulse response varies smoothly across the output space. This preconception can be expressed mathematically by saying that, simultaneously with expression (1) we would also like to minimize

$${\sum }_{i} ( {\sum }_{j} {\vert {\sum }_{k} {r}_{k} {a}_{i , j - k} \vert}^{2} ) , \qquad ( 23 )$$

where the new filter, r, acts to roughen filter coefficients along the output axis of a. Combining expressions (1) and (4) with a parameter, ε, that describes their relative importance, we can write a pair of fitting goal:

Ba−d≈0 (24)

εRa≈0 (25)

By making the change of variables, q=Ra=S⁻¹a we obtain the following fitting goals:

BSa−d≈0 (26)

εq≈0, (27)

which are equivalent to the normal equations

(SB^{T}BS+ε²I)q=S^{T}B^{T}d^{T}. (28)

Equation (28) describes a preconditioned linear system of equations the solution to which converges rapidly under an iterative conjugate gradient solver.

FIG. 7 illustrates the key steps in algorithm for predicting receiver ghosts of primaries only.

Step 701: Predict the field of free surface multiples and receiver ghosts of primaries by a multidimensional convolution of the data with direct waves and data without direct waves. We denote this field Φ₁.

Step 702: Predict the field of free-surface multiples by a multidimensional autoconvolution of the data without direct waves. We denote this field Φ₁′.

Step 703: Take the difference Φ₁−αΦ₁′ to obtain the field of receiver ghosts of primaries. Use the noise cancellation described above or any other similar adaptive subtraction solutions like those described in Haykin (1995) to obtain α. In this difference, Φ₁′ is considered the noise.

This algorithm can be used for decoded data, single shot recorded data, or multishot recorded data.

3. Up/Down Based Multiple Attenuation Solution: Algorithm #2

Our solution is based on the up/down separation technique. The up/down based approach exploits the fact that the polarities of the upgoing and downgoing events for a pressure wavefield are different from those of the particle velocity wavefield to separate upgoing and downgoing events from seismic data. One way to obtain the required upgoing and downgoing wavefields is to record (or estimate) the vertical component of the particle velocity alongside the pressure recording in the multishot experiment. We can then use for example the classical formulae of up/down separation presented in Ikelle and Amundsen (2005). If we let V be the Fourier transform of the vertical component of the particle velocity with respect to time, P be the Fourier transform of the pressure data with respect to time, we can obtain the upgoing and downgoing fields as follows:

$$\begin{matrix}U = \frac{1}{2} ( P - \frac{ωρ}{{k}_{z}} V ) & ( 29 ) \\ D = \frac{1}{2} ( P + \frac{ωρ}{{k}_{z}} V ) & ( 30 ) \\ {U}^{V} = \frac{1}{2} ( V + \frac{{k}_{z}}{ωρ} P ) & ( 31 ) \\ {D}^{V} = \frac{1}{2} ( V + \frac{{k}_{z}}{ωρ} P ) , & ( 32\end{matrix}$$

where U and D are upgoing and downgoing components of the pressure, respectively, and U^{(V)} and D^{(V)} are upgoing and downgoing components of the particle velocity, respectively. The quantity ρ here is the density of water, k_{z}=\sqrt{k²−kₓ²−k_{y}²} is the vertical wavenumber, with k=ω/c and c is the wave propagation velocity in the water. Because this process is performed in the shot gather domain it can be applied to multishot data without any modification. The upgoing wavefield still contains free surface multiples in addition to primaries. For this reason a second step is needed in the up/down based demultiple to attenuate the remaining free surface multiple from the upgoing wavefield. This second step consists of deconvolving the upgoing wavefield by the downgoing wavefield. For example, one can use the following formula,

$$\begin{matrix}\hat{P} = - \frac{s}{2 i {k}_{z}} \frac{P}{D} \\ or & ( 33 ) \\ \hat{P} = - \frac{s}{2 iωρ} \frac{P}{{D}^{( V )}} , & ( 34 )\end{matrix}$$

for such deconvolution; the field P is the deconvolved pressure data, and s=s(ω) is the source signature. In practice, this deconvolution will be carried out on multishot gather per multishot gather under the assumption that the medium is one-dimensional. Therefore, this deconvolution can be applied to multishot data without the need to form CMP or receiver gathers which are not readily available in the context of multishoot acquisition. So in summary, the up/down based demultiple for multishot data can be described in three steps as shown in FIG. 8.

Step 801: Record pressure and particle velocity in the multishot experiment (or estimate particle velocity from pressure recordings).

Step 802: Perform and up/down separation as described above, for example.

Step 803: Deconvolve the data using either the downgoing wavefield or the upgoing wavefield (as described above, for example) to obtain the multishot data free of free surface multiples.

4. Kirchhoff Multiple Attenuation of Multishoot Data

A 1D-Mode:l Algorithm #3

Let us now turn to the problem of demultipling multishot data using the inverse Kirchhoff series algorithm. As described earlier, this algorithm has essentially two parts: (i) the prediction of free-surface multiples and (ii) the subtration of predicted multiples from the data. We can observed that the prediction of multiples through (2) require data to be available in both shot gathers and receiver gathers [Φₙ₋₁(xₛ,yₛ,ω,x,y) are the shot-gather data and V₀^{(nd)}(x,y,ω,xᵣ,yᵣ) are receiver-gather data]. Unfortunately, the multishot data are only in the shot gather form. One approach for overcoming this limitation is to simulate at least for the demultiple purpose, a multishot form of receiver gathers. That is the challenge that we will take in later sections. An alternative solution is to predict multiples under the assumption that the earth is one-dimensional (the medium is only depth-dependent) and to compensate for the modeling errors associated with this assumption at the subtraction step of the predicted multiples from the data.

To fully describe this approach let us start by recalling that under the assumption that earth is 1D, the data Φ₀(xᵣ,yᵣ,xₛ,yₛ,ω) depend only on the offset coordinates xₕ=xᵣ−xₛ and yₕ=yᵣ−yₛ; i.e.,

Φ₀(xᵣ,yᵣ,xₛ,yₛ,ω)=Φ₀(xᵣ−xₛ;yᵣ−yₛ,0,0, ω)=\hat{Φ}₀(xₕ,yₕ,ω). (35)

In other words, the data are now independent of the CMP position (xₘ=xᵣ+xₛ, yₘ=yᵣ+yₛ) the f-k. It is useful in this case to work in the f-k domain to predict multiples because the integrals over x and y in (2) are now convolution operations. As shown in Ikelle et al. (1997), the series can now be written as follows:

\hat{Φ}_{P}(k,k′ω)=\hat{Φ}₀(k,k′ω)+α(ω)\hat{Φ}₁(k,k′ω)+α²(ω)\hat{Φ}²(k,k′ω)+ . . . , (36)

where \hat{Φ}₀(k,k′ω) is the Fourier transform of \hat{Φ}₀(xₕ,yₕ,ω) with respect to xₕ and yₕ, \hat{Φ}_{P} represents the data without a free-surface reflection in the f-k domain. The fields Φ₁ Φ₂, etc., are given by

Φₙ(k,k′ω)=Φₙ₋₁(k,k′ω)\hat{V}₀^{nd)}(k,k′ω), (37)

where \hat{V}₀^{nd)}(k,k′ω) is the vertical component of the particle velocity without the direct wave in the f-k domain. Again, we have used the same symbol with different arguments because the context unambiguously indicates the quantity currently under consideration.

Note that the ID assumption here is applied locally to each multishot gather separately. In other words the series in (36) and the prediction of multiples in (37) are applied to each shot gather separately. Predicted multiples by this approach produces some errors in amplitudes and traveltimes compared to the actual multiples contained in the data. These errors vary with offsets and times and therefore the subtraction techniques in (6)-(10) are not adequate in this case. So we propose to use the adaptive noise cancellation described in (20)-(28) to obtain \hat{Φ}_{P} by assuming that \hat{Φ}₁ is the reference noise and \hat{Φ}₀ is the primary signal plus noise. FIG. 9 illustrates the algorithm for attenuation of multishoot data—1D model that can be summarized as follows:

Step 901: Input a multishot gather.

Step 902: Predict as described in (37) by computing \hat{Φ}₁.

Step 903: Take the difference \hat{Φ}₀−α\hat{Φ}₁ to obtain the field of receiver ghosts of primaries. Use the noise cancellation described above or any other similar adaptive subtraction solution like those described in Haykin (1995) to obtain α. In this difference, \hat{Φ}₁ is considered the noise.

Step 904: Repeat steps 901 to 903 for all the multishot gathers of the multishot data.

An alternative implementation based on the concept BMG described can be formulated as follows. Let us denote by \hat{Φ}₀^{α} the portion of towed-streamer data located above the hypothetical primary associated with the BMG reflector. The first step of our linear solution is

\hat{Φ}ₚₐ=\hat{Φ}₀+α\hat{Φ}₁ₐ, (38)

where \hat{Φ}₁ₐ is computed as a multidimensional convolution of \hat{V}₀^{a} by \hat{Φ}₀.

Let us denote by \hat{V}_{pα}^{b} the portion of \hat{V}_{pα} (i.e., the component of a corresponding to the particle velocity) located below the hypothetic primary associated with the BMG reflector. The second step of our linear solution can be expressed as follows:

\hat{Φ}_{pb}=\hat{Φ}ₚₐ+α\hat{Φ}_{1b}, (39)

where \hat{Φ}_{1b} is computed as a multidimensional convolution of \hat{V}_{pα}^{b} by \hat{Φ}₀^{α}.

FIG. 10 illustrates algorithm of an alternative implementation of a ID-model based on the concept BMG.

Step 1001: Input a multishot gather.

Step 1002: Define the BMG and construct the portion of data located above the BMG. We denote this portion of data \hat{Φ}₀^{α}

Step 1003: Perform a multidimensional convolution of the portion of the particle velocity data located above the BMG and the actual data in full (i.e., the multidimensional convolution of \hat{V}₀^{a} by \hat{Φ}₀ to obtain the field of predicted multiples. We denote this field \hat{Φ}₁ₐ.

Step 1004: Take the difference \hat{Φ}ₚₐ=\hat{Φ}₀−α\hat{Φ}₁ₐ to obtain data without multiples. Use the noise cancellation described above or any other similar adaptive subtraction solution like those described in Haykin (1995) to obtain α.

In this difference, \hat{Φ}₁ₐ is considered the noise.

Step 1005: Construct the portion of data located below the BMG of \hat{Φ}ₚₐ. We denote this portion of data as \hat{Φ}_{pα}^{b}.

Step 1006: Perform a multidimensional convolution of the portion of the particle-velocity data of \hat{Φ}ₚₐ located below the BMG and the portion of the actual data located above the BMG (i.e., multidimensional convolution of \hat{V}_{pα}^{b} by \hat{Φ}₀^{α} to obtain the field of predicted multiples. We denote this field \hat{Φ}_{1b}.

Step 1007: Take the difference \hat{Φ}_{pb}=\hat{Φ}_{pα}−α\hat{Φ}_{1b} to obtain data without multiples. Use the noise cancellation described above or any other similar any other adaptive subtraction solution like those described in Haykin (1995) to obtain α. In this difference, \hat{Φ}_{1b} is considered the noise.

Step 1008: If the shot gather still contains residual multiples, lower the BMG and repeat steps 1002 through 1007.

Step 1009: Repeat the process from step 1001 to step 1008 for all the multishot gathers.

In some cases, the traveltime errors can be so large that the adaptive filters can consider some primaries as shifted multiples, and we may then end up attenuating primaries instead of primaries. An alternative way of to a linear solution in (13)-(16) in which the output is the receiver ghosts of primaries instead of primaries themselves. The idea consists of generating Φ₁(k,k′ω) with the data Φ₀(k,k′ω) containing the direct wave. We then repeat the same calculation with direct wave removed from Φ₀(k,k′ω). We denote the new result Φ₁′(k,k′ω). The calibrated difference between them is then used to obtain the field of receiver ghosts of primaries. The calibrated difference is performed by using the noise cancellation technique described earlier. The interesting feature here is that Φ₁(k,k′ω) and Φ₁′(k,k′ω) contain the same errors in traveltimes and amplitudes. Therefore the subtraction process here is not affected by these errors.

FIG. 11 illustrates algorithm of an alternative way of to a liner solution in (13)-(16) in which the output in the receiver ghosts of primaries instead of primaries themselves.

Step 1101: Input a multishot gather.

Step 1102: Create a version of this multishot gather without direct waves by using the muting process, for example.

Step 1103: Generate Φ₁ with the data \hat{Φ}₀ containing the direct wave.

Step 1104: Generate \hat{Φ}₁′ for the case in which \hat{Φ}₀ does not contain the direct wave.

Step 1105: Take the difference \hat{Φ}₁−α\hat{Φ}₁′ obtain the field of receiver ghosts of primaries. Use the noise cancellation described above or any other similar adaptive subtraction solution like those described in Haykin (1995) to obtain α. In this difference \hat{Φ}₁′ is considered the noise.

Step 1106: Repeat the first five steps of this process for all the multishot gathers in the data.

5. Kirchhoff Multiple Attenuation of Multishot Data—An F-K Model: Algorithm #4

Instead of predicting multiples as if the earth is a 1D medium, we here propose an approach for a multidimensional earth. Basically we are constructing a substitute for the receiver-gather domain [i.e., V_{D}(x,y,ω,xᵣ,yᵣ)] which is not readily available in the multishooting context. Yet we need this field for the multidimensional convolution described in (2) for predicted multiples.

Let us denote by xₛ the position of the first shot of a multishot array, and by xᵣ the receiver positions. Alternatively we will also denote these positions by xₘₙ, where the index m indicates the multishooting array under consideration and the index n indicates the shot point of the m-th multishooting array as illustrated in FIG. 5. If we have a survey of N multishot gathers, and if each multishot array has I shot points, then in will vary from 1 to I, and n will vary from 1 to N. The number of shot points in the entire survey will be N×I. The position of the multishot arrays can be described by either xₛ or by xₙ₁. We assume that receiver-point locations are chosen to coincide or interpolated to coincide with shot point locations through the entire survey. Therefore we can describe the receiver points by xᵣ or equivalently by xₘₙ. Based on these notations, we can define the field of predicted multiples Φₖ (with K=1, 2, 3, . . . ) of multishot data as follow:

$$\begin{matrix}{Φ}_{k} ( {x}_{x} , ω , {x}_{r} ) = {\sum }_{m = 1}^{N} {\sum }_{n = 1}^{I} {Φ}_{k - 1} ( {x}_{s} , ω , {x}_{nm} ) {\hat{V}}_{0} ( {x}_{nm} , ω , {x}_{r} ) . \\ where & ( 40 ) \\ {\hat{V}}_{0} ( {x}_{nm} , ω , {x}_{r} ) = exp [ - {iωτ}_{mn} ] {V}_{0} ( {x}_{s} , ω , {x}_{r} ) & ( 41 )\end{matrix}$$

and where xₛ=xₙ₁, τₘₙ is the ring time of the n-th shot of the m-th multishot array. So the difference between the demultiple of conventional single shot data in (2) and the demultiple of multishot data is that we have introduced the feature of source encoding directly into the equation of the prediction of multiples to overcome the fact that we are dealing with multishot gathers rather than single-shot gathers.

We have discovered that Φₖ contains the desired predicted multiples. But it also contains artifacts. If the time-delays τₘₙ are invariant with m, these artifacts appear as coherent events with different moveouts from those of the multiples. Therefore, the artifacts can be removed from Φₖ by using filtering techniques like F-K filtering, radon ltering etc.

FIG. 12 illustrates an algorithm of multiple attenuation of multishot data by using F-K filtering techniques.

Step 1201: Input multishot data in the form of multishot gathers.

Step 1202: Predict the field of multiples Φₖ(xₛ,ωxᵣ) using (40)-(41).

Step 1203: Filter the artifacts contained in Φₖ(xₛ,ω,xᵣ) which are due to the approximation of the receiver-gather sections in (41). One can use F-K filtering for example, for this operation.

Step 1204: Subtract predicted multiples from the data using the subtraction solution described in (6)-(10), the adaptive noise cancellation described in (20)-(28), or any other adaptive subtraction solution like those described in Haykin (1995).

Step 1205: If the demultiple process requires iterations then go back to step 1202, using the output of step 1204 as the input data.

6. Kirchhoff Multiple Attenuation of Multishot Data—An Underdetermined ICA Model: Algorithm #5

As pointed out earlier, the field predicted based on (40)-(41) contains multiples as well as artifacts. An alternative way of handling the artifacts problem contained in the field of predicted multiples generated via is to use independent component analysis (ICA) techniques. This approach is particularly interesting because it will work even for the cases in which the artifacts component of Φₖ(xₛ,ω,xᵣ) is not coherent. That is the case when the time-delays τₘₙ vary with multishot positions.

The problem of separating artifacts from the actual multiples can be posed as follows. We basically can express the field of predicted multiples, which we now denote Φ₁ to simplify the notation as follows:

Φ=(M+A′)*α, (42)

where M is the predicted multiples and A′ is the field containing the artifacts that we would like to eliminate. For applying ICA separation we need at least one more equation. This equation is given by the actual data,

Φ₀=P+M. (43)

To ensure that multiples in the data and the predicted multiples have of the same scale for an adequate separation using the instantaneous ICA technique, we have added the inverse source a to (42). Because we have only two mixtures for three unknowns signals we have resorted to a linear programming scheme described for separating these three signals.

Notice that we now have an underdetermined-ICA (independent component analysis) type of problem that we can solve by using the sparsity based algorithms described in Application 60/894,182, or by using the concept of virtual mixtures described in application 60/894,182. So systems (64) and (61) can be written

$$\begin{matrix}( \begin{matrix}{Φ}_{0}^{′} \\ {Φ}_{1}\end{matrix} ) = ( \begin{matrix}1 & 1 & 0 \\ 0 & 1 & 1\end{matrix} ) ( \begin{matrix}P \\ M \\ {A}^{′}\end{matrix} ) \\ or & ( 44 ) \\ Y = AX \\ where & ( 45 ) \\ Y = ( \begin{matrix}{Φ}_{0} \\ {Φ}_{1}\end{matrix} ) , X = ( \begin{matrix}P \\ M \\ {A}^{′}\end{matrix} ) , A = ( \begin{matrix}1 & 1 & 0 \\ 0 & 1 & 1\end{matrix} ) & ( 46 )\end{matrix}$$

Alternatively we can consider the case in which the multiples have already been removed from Φ₀ using the adaptive noise cancellation in (20)-(28) or the subtraction technique in (6)-(10). The demultiple is then

Φ₀′→P+A. (47)

Notice that the demultiple data no longer contain multiples, but it will contain the artifacts. So the system becomes

$$\begin{matrix}( \begin{matrix}{Φ}_{0}^{′} \\ {Φ}_{1}\end{matrix} ) = ( \begin{matrix}1 & 1 & 0 \\ 0 & 1 & 1\end{matrix} ) ( \begin{matrix}P \\ {A}^{′} \\ M\end{matrix} ) \\ or & ( 48 ) \\ Y = AX \\ where & ( 40 ) \\ Y = ( \begin{matrix}{Φ}_{0} \\ {Φ}_{1}\end{matrix} ) , X = ( \begin{matrix}P \\ {A}^{′} \\ M\end{matrix} ) , A = ( \begin{matrix}1 & 1 & 0 \\ 0 & 1 & 1\end{matrix} ) . & ( 50 )\end{matrix}$$

We can use the L₁ norm minimization [sometimes referred to as the basis pursuit] or the shortest-path algorithm by working on a data point basis (i.e. piecewise). This approach assumes that the number of single shot gathers active at any one data point is less than or equal to two. Mathematically we can pose the L₁ norm minimization as

$${min}_{X ( l )} \{ {\sum }_{i} \vert {X}_{i} ( l ) \vert \} subject to Y ( l ) = AX ( l ) . \qquad ( 51 )$$

This minimization can be accomplished by formulating the problem as a standard linear program (with only positive coefficients) by separating positive and negative coefficients. Making the substitutions, X←[U;V], and A←[A,−A], equation (51) becomes

min_{U,V} c^{T}[U;V] subject to Y=[A,−A][U;V], U,V≧0, (52)

where c=[1, . . . , 1] the mixing matrix A is replace with one that contains both positive and negative copies of the vectors. This separates the positive and negative coefficients of solution X into the positive variables U and V respectively. (52) can be solved efficiently and exactly with interior point linear programming methods or quadratic programming approaches.

An alternative way to accomplish the L₁ norm minimization is the so called “shortest path technique”. The starting point of this idea is to construct the scatterplot of mixtures with the direction of data concentration being the columns of the mixing matrix (a₁, a₂ and a₃ are the columns of the matrix A and therefore the directions of data concentration). For a given data point l, which is associated to Y(l), we can obtain the optimal values of single-shot gathers at the data point l by the shortest path from the data point to the data point which includes the direction of data concentration. It turns out that this shortest path can be obtained by taking the two directions of data concentration which are the closest to the data point l.

Consider now the mixture data vector Y(l), at data point at which all three single-shot gathers contribute to the mixtures. In this case two of the three directions of the data concentration will be located above or below the direction of Y(l). In FIG. 6, for example the two directions are located below the direction of Y(l). In other words θ₂ and θ₃ are smaller than θ_{R}. The basic idea here is to find the direction of the vector X_{b}(l)=X₁(l)a₁+X₂(l)a₂. Let us then denote this direction by a_{b} and the angle associated with it by θ_{b}. We can then reduce the mixing matrix to Aᵣ=[a₁ a_{b}, to recover X₂(l) and Xₛ(l). By inverting the following system

$$( \begin{matrix}{X}_{b} ( l ) cos {θ}_{b} \\ {X}_{b} ( l ) sin {θ}_{b}\end{matrix} ) = ( \begin{matrix}cos {θ}_{2} & cos {θ}_{3} \\ sin {θ}_{2} & sin {θ}_{3}\end{matrix} ) ( \begin{matrix}{X}_{2} ( l ) \\ {X}_{3} ( l )\end{matrix} ) , \qquad ( 53 )$$

we can also recover X₂(l) and X₃(l). The fundamental remaining question still to resolve is that of estimating a_{b} or angle θ_{b}. We know that θ_{b} is located between θ₂ and θ₂. One approach is to explore all the angles between θ₂ and θ₃, choosing the one which

$$𝒥 = {\sum }_{i = 1}^{3} {\sum }_{j = 1}^{3} \vert {X}_{i} ( l ) {X}_{j} ( l ) \vert , i \neq j . \qquad ( 54 )$$

is minimal. As illustrated in FIG. 6, this criterion is good enough to estimate θ_{b}.

FIG. 13 illustrates an algorithm of Kirchhoff multiple attenuation of multishot data with undertermined ICA model.

Step 1301: Input multishot data in the form of multishot gathers

Step 1302: Predict the field of multiples using Φₖ(xₛ,ω,xᵣ) using (40)-(41).

Step 1303: Use an ICA model for a 2×3 mixture system to separate primary field from the data.

7. Kirchhoff Multiple Attenuation of Multishot Data—A Noisy ICA Model: Algorithm #6

Instead of posing the demultiple as an underdetermined ICA problem, as we did in the previous section we can pose the problem as a noisy ICA model by rewriting (44) as follows:

$$\begin{matrix}( \begin{matrix}{Φ}_{0} \\ {Φ}_{1}\end{matrix} ) = ( \begin{matrix}1 & 1 \\ 0 & 1\end{matrix} ) ( \begin{matrix}P \\ M\end{matrix} ) + ( \begin{matrix}0 \\ {A}^{′}\end{matrix} ) \\ or & ( 55 ) \\ Y = AX + N , \\ where & ( 56 ) \\ Y = ( \begin{matrix}{Φ}_{0} \\ {Φ}_{1}\end{matrix} ) , X = ( \begin{matrix}P \\ M \\ {A}^{′}\end{matrix} ) , A = ( \begin{matrix}1 & 1 & 0 \\ 0 & 1 & 1\end{matrix} ) . & ( 57 )\end{matrix}$$

Therefore the field containing the artifacts is no longer treated as an independent component but as noise. Let us denote W the inverse of A. Applying this inverse matrix to Y, we obtain

X′=X+WN. (58)

In other words, we get only noisy estimates of the independent components. Therefore, we would like to obtain estimates of the original independent components, Xi, that are somehow optimal, i.e., contain minimum noise. One approach to this problem is to use the maximum a posteriori MAP estimates. This means that we take the values that have maximum probability given the Y. Equivalently, we take as Xi those values that maximize the joint likelihood so this could also be called a maximum likelihood (ML)estimator.

To compute the MAP estimator, let us take the gradient of the log likelihood with respect to the X(l) and equate this to 0. Thus we obtain the equation

A^{T}C⁻¹AX(l)−A^{T}C⁻¹Y(l)+f′┌X(l)┘=0, (59)

where the derivative of the log density, denoted by f′, is applied separately to each component of the vector X(l). C is the covariance noise. In fact, this method gives a nonlinear generalization of the classic Wiener filtering. An alternative approach would be to use the time structure of the independent components for denoising. This result in a method resembling the Kalman filter.

FIG. 14 illustrates at algorithm of Kirchhoff multiple attenuation of multishot data using a noisy ICA model.

Step 1401: Input multishot data in the form of multishot gathers.

Step 1402: Predict the field of multiples Φₖ(xₛ,ω,xᵣ) using (40)-(41).

Step 1403: Use an ICA model for a 2×2 mixture system to separate primaries field from the data. The artifacts effects are treated in the ICA as noise.

9. The Phenomenon of Low and High Tides in the Demultiple Process—An Underdetermined ICA Model Algorithm: #7

We here describe how seismic acquisition technology can be used to eliminate free surface multiples. This process is valid for conventional single shot data as well as multishot data.

Primaries and internal multiples are the only seismic events that can be shielded from the effects of changes in the physical properties of the near sea surface during seismic acquisition, whereas free surface multiples and ghosts cannot be shielded because of their interaction with the sea surface. So we can exploit naturally occurring changes in the sea surface (i.e., the phenomenon of high and low tides to differentiate primaries and internal multiples from free surface multiples and ghosts. Obviously, we can also exploit any artificial changes in sea surface conditions for the same purpose.

One of the possible natural causes of changes in the properties of the sea surface is the phenomenon of the alternating rise and fall in sea levels with respect to land. This phenomenon is known as tides. Tides result from a combination of two basic forces: (1) the force of gravitation exerted by the moon upon the earth and (2) centrifugal forces produced by the revolutions of the earth and moon around their common center of gravity (mass). The most familiar evidence of tides along the coastlines is high and low water—usually, but not always twice daily. Tides typically have ranges (vertical, high to low) of two meters, but there are regions in oceans where various conditions conspire to produce virtually no tides at all (e.g., in the Mediterranean Sea, the range is 2 to 3 cm) and others where the tides are greatly amplified (e.g., on the northwest coast of Australia the range can be up to 12 m, and in the Bay of Fundy, Nova Scotia, it can go up to 15 m).

To eliminate free surface multiples and ghosts from our data we can conduct two experiments one under fow tide conditions and the other one under high tide conditions. During the two experiments, we must geek to keep the depth of the source relatively constant with respect to the sea floor so that primaries resulting from these two experiments will be almost identical. Obviously, such types of acquisition will take advantage of the enormous progress made in recent years in our capability to repeat seismic surveys for a set of desirable conditions.

Let us look at how the results of the low- and high-tide experiments can be used to produce data without ghosts and free surface multiples. Let us denote by D₁ the data corresponding to the low tide experiment and by D₂ the data corresponding to the high tide experiment. We can write these data as follows:

$$\{ \begin{matrix}{D}_{1} = P + {M}_{1} \\ {D}_{2} = P + {M}_{2} .\end{matrix} \qquad ( 60 )$$

P is the field of primaries that we are interested in reconstructing; M₁ and M₂ are fields containing ghosts and free surface multiples. We can alternatively form these two equations:

$$\{ \begin{matrix}{D}_{1}^{′} = {D}_{1} + {D}_{2} = 2 P + {M}_{1} + {M}_{2} \\ {D}_{2}^{′} = {D}_{1} - {D}_{2} = {M}_{1} - {M}_{2} .\end{matrix} \qquad ( 61 )$$

Notice that we now have an underdetermined-ICA (independent component analysis) type of problem that we can solve by using the sparsity based algorithms described in Application 60/894,182 or by using the concept of virtual mixtures described in application 60/894,182. So the systems (64) and (61) can be written

$$\begin{matrix}( \begin{matrix}{D}_{1} \\ {D}_{2}\end{matrix} ) = ( \begin{matrix}1 & 1 & 0 \\ 1 & 0 & 1\end{matrix} ) ( \begin{matrix}P \\ {M}_{1} \\ {M}_{2}\end{matrix} ) , \\ and & ( 62 ) \\ ( \begin{matrix}{D}_{1}^{′} \\ {D}_{2}^{′}\end{matrix} ) = ( \begin{matrix}2 & 1 & 1 \\ 0 & 1 & - 1\end{matrix} ) ( \begin{matrix}P \\ {M}_{1} \\ {M}_{2}\end{matrix} ) . & ( 63 )\end{matrix}$$

Our experience suggests that system (63) is more suitable for computational implementation especially when using sparsity-based ICA decoding or virtual mixture ICA decoding.

In summary our multiple attenuation algorithm for multishot data and for single shot data can be illustrated in FIG. 15 and summarized as follows:

Step 1501: Collect a marine seismic dataset at a certain sea level z₀. Repeat the experiment by collecting a second dataset at another sea level z₁. Make sure that the sources and receivers are located at the same position with respect to the sea floor during the two experiments. These data can be collected in a multishooting mode or in the mode of the current conventional single shot acquisition.

Step 1502: Apply ICA decoding for underdetermined mixtures as described in application 60/894,182 or the system of equations in (65) or (63), using the fact that seismic data are sparse or by creating an additional mixture based on the adaptive/match filtering or reciprocity theorem.

9. The Phenomenon of Low and High Tides in the Demultiple Process—A Convolutive Mixture ICA Model: Algorithm #8

By assuming that the difference between multiples associated with the low-tide experiments and those associated with high tide experiment is essentially time dependent, we can alternatively describe the mixtures in the F-X domain as follows:

$$\{ \begin{matrix}{D}_{1} ( x , ω ) = P ( x , ω ) + {M}_{1} ( x , ω ) \\ {D}_{2} ( x , ω ) = P ( x , ω ) + A ( ω ) {M}_{1} ( x , ω ) .\end{matrix} \qquad ( 64 )$$

where A(ω) is the term that allows us to correct for the differences between M₁ and M2, defined in the previous section; in other words M2=AM1. So the system (64) can be written

$$( \begin{matrix}{D}_{1} ( x , ω ) \\ {D}_{2} ( x , ω )\end{matrix} ) = ( \begin{matrix}1 & 1 \\ 1 & A ( ω )\end{matrix} ) ( \begin{matrix}P ( x , ω ) \\ {M}_{1} ( x , ω )\end{matrix} ) , \qquad ( 65 )$$

So we can treat each frequency or a group of frequencies as a set of separate instantaneous mixtures which can be demultipled by using the ICA based methods. However, the ICA methods here differ significantly from standard ICA model for at least two reasons. The first reason is that seismic data in the F-X (frequency-space) domain are not sparse; they tend toward Gaussian distributions. The second reason is that the statistics of mixtures varies significantly between frequencies. At some frequencies the data can be described as mixtures of Gaussian random variables. At other frequencies, the data can be described as mixtures of Gaussian and non-Gaussian random variables with the number of Gaussian random variables greater than or equal to two. The ICA methods are generally restricted to mixtures with at most one Gaussian random variable the rest being non-Gaussian. So to accommodate for the fact that at some frequencies the data may correspond to mixtures with one Gaussian random variable at most we here adopted ICA methods in which all the frequencies are demultipled simultaneously. These types of ICA methods are generally known as multidimensional independent component analysis (MICA) methods. This approach allows us to avoid dealing with mixtures of Gaussian random variables.

The uncorrelatedness assumption and statistical-independence assumption on which the ICA decoding methods are based are ubiquitous with respect to the permutations and scales of the single shot gathers forming the decoded data vector. In other words the first component of the decoded-data vector may, for example, actually be α₂H₂(x₂,t) (where a₂ is a constant rather than H₁(xᵣ,t). When the data are treated in the demultiple process as a single random vector, or when all the frequency components of the data are demultiple simultaneously, the demultipled shot gathers can easily be rearranged in the desirable order and resealed properly by using first arrivals and direct wave-arrivals. However demultipling all frequency components can sometimes imply increases in computational requirements. An alternative solution is to divide the frequency spectrum into small bands which can be demultipled separately. This type of demultiple involves several random vectors because each group of frequencies is associated with a random vector. So there are some permutation indeterminacies between these groups of frequencies which must be addressed to properly align the frequency components of each demultipled shot gather before performing the inverse Fourier transform. We can use the fact that seismic data are continuous in time and space to solve for these indeterminacies.

In summary, the demultiple based on the convolutive mixture model is illustrated in FIG. 16 and can be algorithmically cast as follows:

Step 1601: Collect a marine seismic dataset at a certain sea level z₀. Repeat the experiment by collecting a second dataset at another sea level z₁. Make sure that the sources and receivers are located at the same position with respect to the sea floor during the two experiments. These data can be collected in a multishooting mode or in the mode of the current conventional single-shot acquisition.

Step 1602: Take the Fourier transform of the data with respect to time.

Step 1603: Whiten each frequency slice.

Step 1604: Initialize all the decoding matrix Wv as identity matrices, for example.

Step 1605: Apply ICA for each frequency or MICA on all the frequency.

Step 1606: Resealing the results. Let By denote the demixing matrix at the frequency slice v. Deduce B′ᵥ=Diag(Bᵥ⁻¹)Bᵥ

Step 1607: Get the independent components for this frequency slice: Xᵥ′=Bᵥ′Yᵥ.

Step 1608: Take the inverse Fourier transform of X′={Xᵥ′} with respect to frequency.

10. Velocity Estimation Migration and Inversion of Multishot Data: Algorithm #10.

Velocity estimation migration and inversion of single-shot data are based on the mathematical operator (generally known as the migration operator) of this form:

L(xₛ,x,xᵣ,ω)=G(xₛ,x,ω)G(x,xᵣ,ω), (66)

where G(xₛ,x,ω) and G(x,xᵣ,ω are Green's functions or Green's tensors or (a modified form of the Green's function in which the geometrical spreading effect is ignored (or corrected for before the migration), as commonly done in some migration algorithms) describe the wave propagation from the source position xₛ to image point x, and from the image point to the receiver point xᵣ, respectively. The forward modeling problem for predicting seismic data for a given model of the subsurface is

D_{pred}(xₛ,xᵣω)=∫dxL(xₛ,x,xᵣ,ω)W(x) (67)

where W(x) captures the properties of the subsurface such as P-wave and S-wave velocities and P-wave and S-wave impedances. Let us emphasize that D_{pred} are predicted data and not observed data. We denote the observed data by D_{obs}. Inversion consists of solving the forward problem to recover W(x). The analytical solution of the inversion is given by

W=[L̂L]⁻¹L*D_{obs}, (68)

where L is the operator with a kernel L(xₛ,x,xᵣ,ω) and L* is the complex conjugate of L. W and D_{obs} are the operator notations of W(x) and D_{obs}(xₛ,xᵣ,ω), respectively. When the inversion of [L*L]⁻¹ is not possible, an approximation for it is used, and several iterations are needed to reconstruct W(x).

Migration is a particular form of (68) in which modified forms of Green's functions are used in such a way that [L*L] approximates an identity operator. Therefore, the migration algorithm is

M(x)=∫dxᵣ∫dxₛ∫dωL*(xₛ,x,xᵣ,ω),D_{obs}(xₛ,xᵣ, ω) (69)

where M(x) describes migrated images.

For velocity estimation we simply have to run the algorithm in (69) several times in an iterative form for a depth velocity estimation or in a parallel mode for a migration velocity analysis.

To adapt these methods for processing multishot data without decoding them our approach here consists of modifying the operator L so that it can include the features of encoded source signatures. Suppose that the data here are acquired by multishot arrays in which each multishot array has I shot points. The total data then consist of N multishot gathers with each multishot gather being a mixture of I single shot-gathers. As we did in Algorithm #1 for the m-th multishot array, we assume that the firing times of the various shot points are different. We will denote these firing times by τₘₙ, with the subscript m describing the multishot arrays and the subscript n describing the shot points of the m-th multishot array.

Let us denote by xₛ the position of the first shot of the multishot array and by xᵣ the receiver positions. Alternatively we will also denote these positions by xₘₙ where the index m indicates the multishooting array under consideration and the index n indicates the shot point of the m-th multishooting array. If we have a survey of N multishot gathers, and if each multishot array has I shot points then m will vary from to I and n will vary from 1 to N. The number of shot points in the entire survey will be N×I. The position of the multishot arrays can be described by either xₛ or xₙ₁. We assume that the receiver point locations are chosen to coincide or interpolated to coincide with shot point locations through the entire survey. Based on these notations we can compute L of multishot data as follows:

$$L ( {x}_{s} = {x}_{m 1} , x , {x}_{r} , ω ) = {\sum }_{n = 1}^{I} exp [ i ω {τ}_{k m} ] G ( {x}_{n m} , x , ω ) G ( x , {x}_{r} , ω ) . \qquad ( 70 )$$

So we basically just have to replace (66) by (70) in all the migration inversion and velocity-estimation algorithms to image multishot data without decoding them.

FIG. 17 illustrates our algorithm for multishot data or single-shot data that can be summarized as follows:

Step 1701: Reformulate the migration operator in (66) to include the feature of multishot data and of the source signature encoding as described in (70).

Step 1702: Include this new migration operator in the inversion and migration algorithms.

Step 1703: Run the migration and inversion algorithms with this new operator to recover the velocity model of the subsurface and the images of the subsurface.

Let us look at more specific examples.

10.1 Velocity Migration Analysis of Multishot Data.

A solution is to use (66) or any other prestack-time migration algorithms in which the operator can be incorporated. Many constant velocity migrations are performed for a number of velocities between Vₘᵢₙ and Vₘₐₓ, with a step of ΔV. The velocity estimation based on prestack time migration is known as velocity-migration analysis. Note that the final migration image can be formed from scans by merging parts of each constant-velocity migration so that every part of the final image is based on the right velocity.

FIG. 18 illustrates an algorithm for velocity migration analysis of multishot data.

Step 1801: Reformulate the constant velocity migration operator using the operator (66) to include the features of multishot data and of source signature encoding, as described in (70).

Step 1802: Perform this new migration for velocity between a predefined velocity interval, Vmin and Vmax at the increment ΔV.

Step 1803: Use the classical focusing defocusing criteria to estimate the velocity model.

10.2 Velocity-Building

Before depth imaging can take place an accurate velocity model in depth must be created, or alternatively, the depth imaging and accurate velocity model in depth must be obtained simultaneously. First of all, the velocity model is considered as a series of velocity functions. The process of constructing these functions is generally called velocity model-building.

Model building is an iterative process, most commonly layer by layer, in which new information is constantly fed into the model to refine the final result. As in any iterative process the first step is to create an initial model.

Creating an Initial-Velocity Model

The two types of velocities that are commonly used in creating an initial-velocity model from seismic data are rms velocity (from time imaging) and interval velocities. The rms velocities are picked from the semblance plots of CMP gathers and then converted to interval velocities, using, for instance Dix's formula. These interval velocities are used to construct a starting model. Smoothing the interval velocities is critical because an unsmoothed velocity field may contain abrupt changes which can introduce a false structure to the final depth-migrated section.

Iterative Process

The first step is to run the prestack depth migration (PSDM) using the initial velocity model. One can use the prestack depth migration PSDM or any PSDM in which the operator can be incorporated.

The next step is the process of residual moveout (RMO) analysis. RMO is the amount of residual moveout observed on the CRP (common reflection point gathers). After RMO analysis we then modify the velocity so that the RMO is minimized on the CRP gathers.

There are two basic ways to effectively attain a final-velocity model the layer by layer approach and the global scheme. The layer by layer approach involves working on one layer at a time starting with the top horizon. Each layer will have geophysical and geological constraints. As the top layer is finalized and its velocity converges to a “true” value, the processor “locks” that layer into place so that no more velocity changes are made to it. Once this is done the same iterative process is performed on the next layer down. This process is repeated until every layer has been processed individually and the velocity model is complete. This technique is commonly used in areas with the complex structures.

FIG. 19 illustrates algorithm of the global approach involves working with the entire model. Each layer will still have its geophysical and geological constraints. The difference in this approach is that the entire model is modified with each iteration until the entire model converges within a certain tolerance.

Step 1901: Creating an initial velocity model using time imaging for example.

Step 1902: Use a reformulated depth migration algorithm which is based on the multishooting operator has been incorporated in (68)-(69) so that the features of multishot data and of the source-signature encoding, as described in (70).

Step 1903: RMO residual moveout analysis and correction.

Step 1904: Proceed the classical way with a layer by layer approach or a global scheme, as described above.

11. ICASEIS Algorithm #11

In this section we present a new approach to seismic imaging. Instead of performing ICA before imaging or after imaging we propose to based the imaging directly on ICA. We start by writing seismic data in the classical form of Born approximation

$$D ( {x}_{r} , {x}_{s} , ω ) = {\sum }_{j} G ( {x}_{r} , {x}_{s} , ω ) m ( {x}_{j} ) G ( {x}_{j} , {x}_{s} , ω ) \qquad ( 71 )$$

where m(xⱼ) describes inhomogeneity. G(xᵣ,xₛ,ω) and G(xⱼ,xₛ,ω) are Green's functions which describe seismic wave propagation from source xₛ to imaging point x and from the imaging to the receiver xᵣ. Equation (71) can be interpreted as an instantaneous linear mixture. The jth secondary source m(xⱼ)G(xⱼ,xₛ,ω) is weighted by a mixing matrix G(xᵣ,xₛ,ω), and all the weighted secondary sources are mixed to produce the detected D(xᵣ,xₛ,ω). By seeking the maximal mutual statistical independence, both secondary sources and mixing matrices can be obtained by an independent component analysis of the multi source multi receiver data set D(xᵣ,xₛ,ω) according to information theory.

So the scattered wave may be interpreted as an instantaneous linear mixture,

$$\begin{matrix}Y ( {x}_{s} ) = AX ( {x}_{s} ) , \\ where & ( 72 ) \\ Y ( {x}_{s} ) = {[ D ( {x}_{r 1} , {x}_{s} , ω ) , … , D ( {x}_{rK} , {x}_{s} , ω ) ]}^{T} & ( 73 ) \\ X ( {x}_{s} ) = {[ m ( {x}_{1} ) G ( {x}_{1} , {x}_{s} , ω ) , … , m ( {x}_{1} ) G ( {x}_{1} , {x}_{s} , ω ) ]}^{T} & ( 74 ) \\ A = ( \begin{matrix}G ( {x}_{r 1} , {x}_{1} , ω ) & G ( {x}_{r 1} , {x}_{2} , ω ) & … & G ( {x}_{r 1} , {x}_{l} , ω ) \\ G ( {x}_{r 2} , {x}_{1} , ω ) & G ( {x}_{r 2} , {x}_{2} , ω ) & … & G ( {x}_{r 2} , {x}_{l} , ω ) \\ ⋮ & ⋮ & ⋱ & ⋮ \\ G ( {x}_{r K} , {x}_{1} , ω ) & G ( {x}_{rK} , {x}_{2} , ω ) & … & G ( {x}_{rK} , {x}_{l} , ω )\end{matrix} ) & ( 75 )\end{matrix}$$

Here X(xₛ) represents the I virtual sources. A is the mixing matrix, and Y(xₛ) represents the mixtures. Again, the superscript T denotes transposition.

The principal assumption of this formalism is that the virtual source m(xⱼ)G(xⱼ,xₛ,ω) at the jth inhomogeneity is independent of the virtual sources at other locations. Under this assumption, ICA can be used to separate independent sources from linear instantaneous or convolutive mixtures of independent signals without relying on any specific knowledge of the sources except that they are independent. The sources are recovered by a minimization of a measure of dependence such as mutual information between the reconstructed sources. Again, the recovered virtual sources and mixing vectors from ICA are unique up to permutation and scaling.

The two Green's functions wave propagating from the source to the inhomogeneity and from the inhomogeneity to the receiver are retrieved from the separated virtual sources X(xₛ) and the mixing matrix A. The jth element Xj(xₛ) of the virtual source array and the jth column aⱼ mixing vector of the mixing matrix A provide the scaled projections of the Greens functions on the source and receiver planes, G(xⱼ,xₛ,ω) and G(xᵣ,xₛ,ω), respectively. We can write

Xⱼ(xₛ)=αⱼG(xⱼ,xₛ,ω) (76)

αⱼ(xᵣ)=βⱼG(xᵣ,xⱼ,ω), (77)

where αⱼ and βⱼ are scaling constants for the jth inhomogeneity location.

Both the location and the strength at the jth location can be computed by a simple fitting procedure by use of (76)-(77). We adopted a least-square fitting procedure given by

$${min}_{{x}_{j} , {α}_{j} , {β}_{j}} \{ \begin{matrix}{\sum }_{{x}_{y}} {[ {α}_{j}^{- 1} {X}_{j} ( {x}_{s} ) - G ( {x}_{j} , {x}_{s} , ω ) ]}^{2} + \\ {[ {β}_{j}^{- 1} {α}_{j} ( {x}_{s} ) \cdot - G ( {x}_{r} , {x}_{j} , ω ) ]}^{2}\end{matrix} \} \qquad ( 78 )$$

The fitting yields the location xj of and the two scaling constants αⱼ and βⱼ for the jth inhomogeneity, whose strength is then given m(xⱼ)=αⱼβⱼ.

FIG. 20 illustrates the ICASEIS algorithm.

Step 2001: Cast the seismic imaging into an ICA. The seismic data are the mixtures. The independent components are formed as products of the subsurface inhomogeneities and Green's function from the source points to the image points. The mixing matrix is formed with the Green's function from the image points to the receiver points. (This ICA model can be constructed based on the representation of seismic data in terms of the Born scattering integral equation as we described above; in terms of the Lippmann-Schwinger scattering integral equation or in terms of the representation theorem integral equation)

Step 2002: Use the classical ICA technique as described in the Application 60/894,182 or by using the concept of virtual mixtures described in application 60/894,182, for example, to recover the mixing matrix and the independent components.

Step 2003: Determine both the location and the strength of the subsurface inhomogeneities by fitting the Green's function predicted by the ICA model and those predicted by standard migration techniques.

Those skilled in the art will have no difficulty devising myriad obvious variants and improvements upon the invention without undue experimentation and without departing from the invention, all of which are intended to be encompassed within the claims which follow.

1. A method of imaging multishot data without decoding, the method comprising the steps of:
predicting a first field of free-surface multiples and receiver ghosts of primaries by a multidimensional convolution of the data with direct waves and data without direct waves;
denoting the first field Φ₁;
predicting a second field of free-surface multiples by a multidimensional autoconvolution to the data without direct waves;
denoting the second field Φ′₁; and
taking the difference between Φ₁−α′₁ to obtain the field of receiver ghost of primaries, wherein Φ′₁is considered the noise.

2. A method of imaging multishot data without decoding, the method comprising the steps of:
recording pressure and particle velocity in a multishot experiment;
performing an up/down separation techinique; and
deconvolving the data using either a downgoing or a upgoing wavefield to obtain the mutishot data free of free-surface multiples.

3. A method of imaging multishot data without decoding, the method comprising the steps of:
inputting a multishot gather;
predicting Φₙ(k,k′ω)=Φₙ₋₁(k,k′ω)\hat{V}₀^{nd)}(k,k′ω) by computing \hat{Φ}₁;
taking the difference between \hat{Φ}₀−α\hat{Φ}₁ to obtain a field of receiver ghost of primaries, wherein \hat{Φ}₁ is considered the noise; and
repeating the inputting, predicting and taking the difference for the multishot gather of the multishot data.

4. A method of imaging multishot data without decoding, the method comprising the steps of:
inputting a multishot gather;
defining a BMG and constructing a portion of data located above the BMG;
denoting the portion of the data as \hat{Φ}₀^{α};
performing a multidimensional convolution of the portion of a particle-velocity data located above the BMG and an actual data in full to obtain the field of predicted multiples by denoting the field as \hat{Φ}₁ₐ;
taking the difference \hat{Φ}ₚₐ=\hat{Φ}₀−α\hat{Φ}₁ₐ to obtain a data without multiples, wherein \hat{Φ}₁ₐ is considered the noise;
constructing a portion of data located below the BMG of \hat{Φ}ₚₐ by denoting the portion of data as \hat{Φ}_{pα}^{b};
performing a multidimensional convolution of the portion of the particle-velocity data of \hat{Φ}ₚₐ located below the BMG and the portion of the actual data located above the BMG to obtain the field of predicted multiples by denoting the field \hat{Φ}_{1b};
taking the difference \hat{Φ}_{pb}=\hat{Φ}_{pα}−α\hat{Φ}_{1b}, wherein \hat{Φ}_{1b} is considered the noise;
if the multishot gather containing residual multiples, lowering the BMG and returning to the defining the BMG step; and
repeating the method from the inputting step to the taking the difference step for the multishot gather.

5. The method of claim 4, wherein the multidimensional convolution is multidimensional convolution of \hat{V}₀^{α} by \hat{Φ}₀.

6. A method of imaging multishot data without decoding, the method comprising the steps of:
inputting a multishot gather;
creating a version of said multishot gather without a direct wave;
generating Φ₁ with the data \hat{Φ}₀ containing the direct wave;
generating \hat{Φ}₁′ for the case in which \hat{Φ}₀ does not contain the direct wave;
taking the difference \hat{Φ}₁−α\hat{Φ}₁′ to obtain the field of receiver ghosts of primaries, wherein \hat{Φ}₁ is considered the noise; and
repeating the method from the inputting step to the taking the difference step for the multishot gather.

7. A method of imaging multishot data without decoding, the method comprising the steps of:
inputting a multishot data in the form of a multishot gather;
predicting the field of multiples Φₖ(xₛ,ω,xᵣ);
filtering an artifacts contained in Φₖ(xₛ,ω,xᵣ) which are due to the approximation of the receiver-gather sections;
subtracting predicted multiples from the data using the subtraction solution and the adaptive noise cancellation; and
if the demultiple process requires iterations, returning to the predicting the field of multiples step using the output of the subtracting step.

8. The method of claim 7, wherein the step of predicting the field of multiples Φₖ(xₛ,ω,xᵣ) is done by:
$${Φ}_{k} ( {x}_{s} , ω , {x}_{r} ) = {\sum }_{m = 1}^{N} {\sum }_{n = 1}^{I} {Φ}_{k - 1} ( {x}_{s} , ω , {x}_{n m} ) {\hat{V}}_{0} ( {x}_{n m} , ω , {x}_{r} ) ,$$
wherein
\hat{V}₀(xₙₘ,ω,xᵣ)=exp[−iωτₘₙ]V₀(xₛ,ω,xᵣ)

9. The method of claim 7, wherein the step of filtering the artifacts is F-K filtering.

10. A method of imaging multishot data without decoding, the method comprising the steps of:
inputting a multishot data in the form of a multishot gather;
predicting the field of multiples Φₖ(xₛ,ω,xᵣ) ; and
using an ICA model for 2×3 mixture to separate primary field from the data.

11. The method of claim 10, wherein the step of predicting the field of multiples Φₖ(xₛ,ω,xᵣ) is done by:
$${Φ}_{k} ( {x}_{s} , ω , {x}_{r } ) = {\sum }_{m = 1}^{N} {\sum }_{n = 1}^{I} {Φ}_{k - 1} ( {x}_{s} , ω , {x}_{n m} ) {\hat{V}}_{0} ( {x}_{n m} , ω , {x}_{r} ) ,$$
wherein
\hat{V}₀(xₙₘ,ω,xᵣ)=exp[−iωτₘₙ]V₀(xₛ,ω,xᵣ)

12. A method of imaging multishot data without decoding, the method comprising the steps of:
inputting a multishot data in the form of a multishot gather;
predicting the field of multiples Φₖ(xₛ,ω,xᵣ); and
using an ICA model for 2×2 mixture to separate primary field from the data.

13. The method of claim 12, wherein the step of predicting the field of multiples Φₖ(xₛ,ω,xᵣ) is done by:
$${Φ}_{k} ( {x}_{s} , ω , {x}_{r} ) = {\sum }_{m = 1}^{N} {\sum }_{n = 1}^{I} {Φ}_{k - 1} ( {x}_{s} , ω , {x}_{n m} ) {\hat{V}}_{0} ( {x}_{n m} , ω , {x}_{r} ) ,$$
wherein
\hat{V}₀(xₙₘ,ω,xᵣ)=exp[−iωτₘₙ]V₀(xₛ,ω,xᵣ)

14. A method of imaging multishot data without decoding, the method comprising the steps of:
collecting a first marine seismic dataset at a first sea level Z₀;
repeating the experiment by collecting a second dataset at second sea level Z₁;
making sure that sources and receivers are located at the same position with respect to the sea floor during the two experiments; and
applying ICA decoding for undetermined mixtures for the system of equation:
$$( \begin{matrix}{D}_{1}^{′} \\ {D}_{2}^{′}\end{matrix} ) = ( \begin{matrix}2 & 1 & 1 \\ 0 & 1 & - 1\end{matrix} ) ( \begin{matrix}P \\ {M}_{1} \\ {M}_{2}\end{matrix} ) ;$$
and
creating an additional mixture based on the adaptive/match filtering and reciprocity theorem.

15. A method of imaging multishot data without decoding, the method comprising the steps of:
collecting a first marine seismic dataset at a first sea level Z₀;
repeating the experiment by collecting a second dataset at a second sea level Z₁;
making sure that sources and receivers are located at the same position with respect to the sea floor during the two experiments;
applying ICA decoding for undetermined mixtures for the system of equation:
$$( \begin{matrix}{D}_{1} ( x , ω ) \\ {D}_{2} ( x , ω )\end{matrix} ) = ( \begin{matrix}1 & 1 \\ 1 & A ( ω )\end{matrix} ) ( \begin{matrix}P ( x , ω ) \\ {M}_{1} ( x , ω )\end{matrix} ) ;$$
and
creating an additional mixture based on the adaptive/match filtering and reciprocity theorem.

16. A method of imaging multishot data without decoding, the method comprising the steps of:
collecting a first marine seismic dataset at a first sea level Z₀;
repeating the experiment by collecting a second dataset at a second sea level Z₁;
making sure that sources and receivers are located at the same position with respect to the sea floor during the two experiments;
taking the Fourier transform of the data with respect to time;
whitening each frequency slice;
initializing all the decoding matrix Wv as identity matrices;
applying ICA for each frequency;
resealing the results, wherein By denote the demixing matrix at the frequency slice v;
deducing Bᵥ′=Diag(Bᵥ⁻¹)Bᵥ;
getting the independent components for this frequency slice: Xᵥ′=Bᵥ′Yᵥ; and
taking the inverse Fourier-transform of X′=[Xᵥ′} with respect to frequency.

17. A method of imaging multishot data without decoding, the method comprising the steps of:
collecting a first marine seismic dataset at a first sea level Z₀;
repeating the experiment by collecting a second dataset at a second sea level Z₁;
making sure that sources and receivers are located at the same position with respect to the sea floor during the two experiments;
taking the Fourier transform of the data with respect to time;
whitening each frequency slice;
initializing all the decoding matrix Wv as identity matrices;
applying MICA on all frequency;
resealing the results, wherein By denote the demixing matrix at the frequency slice v;
deducing Bᵥ′=Diag(Bᵥ⁻¹)Bᵥ;
getting the independent components for this frequency slice: Xᵥ′=Bᵥ′Yᵥ; and
taking the inverse Fourier-transform of X′={Xᵥ′} with respect to frequency.

18. A method of imaging multishot data without decoding, the method comprising the steps of:
reformulating a migration operator in L(xₛ,x,xᵣω)=G(xₛ,x,ω)G(x,xᵣ,ω) to include the feature of multishot data and of the source-signature encoding
$$L ( {x}_{s} = {x}_{m 1} , x , {x}_{r} , ω ) = {\sum }_{n = 1}^{I} exp [ i ω {τ}_{k m} ] G ( {x}_{n m} , x , ω ) G ( x , {x}_{r} , ω ) ;$$
including said migration operator in the inversion and migration algorithms; and
running the migration and inversion algorithms with this new operator to recover the velocity model of the subsurface and the images of the subsurface.

19. A method of imaging multishot data without decoding, the method comprising the steps of:
reformulating a constant-velocity migration operator using the operator L(xₛ,x,xᵣ,ω)=G(xₛ,x,ω)G(xₛ,x,ω) to include the feature of multishot data and of the source-signature encoding
$$L ( {x}_{s} = {x}_{m 1} , x , {x}_{r} , ω ) = {\sum }_{n = 1}^{I} exp [ i ω {τ}_{k m} ] G ( {x}_{n m} , x , ω ) G ( x , {x}_{r} , ω ) ;$$
performing the migration for velocity between a predefined velocity interval, Vmin and Vmax at the increment ΔV; and
using the classical focusing-defocusing criteria to estimate the velocity model.

20. A method of imaging multishot data without decoding, the method comprising the steps of:
creating an initial-velocity model using time imaging;
using a reformulating depth migration algorithm which is based on the multishooting operator
W=[L*L]⁻¹L*D_{obs} and
M(x)=∫dxᵣ∫dxₛ∫dωL*(xₛ,x,xᵣ,ω), D_{obs}(xₛ,xᵣ,ω) so that the features of multishot data of the source-signature encoding
$$L ( {x}_{s} = {x}_{m 1} , x , {x}_{r} , ω ) = {\sum }_{n = 1}^{I} exp [ i ω {τ}_{k m} ] G ( {x}_{n m} , x , ω ) G ( x , {x}_{r} , ω ) ;$$
applying residual moveout (RMO) analysis encoding; and
proceeding the classical way with a layer-by-layer approach.

21. A method of imaging multishot data without decoding, the method comprising the steps of:
creating an initial-velocity model using time imaging;
using a reformulating depth migration algorithm which is based on the multishooting operator
W=[L*L]⁻¹L*D_{obs} and
M(x)=∫dxᵣ∫dxₛ∫dωL*(xₛ,x,xᵣ,ω), D_{obs}(xₛ,xᵣ,ω) so that the features of multishot data of the source-signature encoding
$$L ( {x}_{s} = {x}_{m 1} , x , {x}_{r} , ω ) = {\sum }_{n = 1}^{I} exp [ i ω {τ}_{k m} ] G ( {x}_{n m} , x , ω ) G ( x , {x}_{r} , ω ) ;$$
applying residual moveout (RMO) analysis encoding; and
proceeding with a global scheme.

22. A method of imaging multishot data without decoding, the method comprising the steps of:
casting the seismic imaging into an ICA, wherein seismic data are a mixing matrix;
forming the independent components as products of the subsurface inhomogeneities and Green's function from the source points to the image points;
forming the mixing matrix with the Green's function from the image points to the receiver points;
using the classical ICA technique to recover the mixing matrix and the independent components;
determining the location and the strength of the subsurface inhomogeneities by fitting the Green's function predicted by the ICA model and those predicted by standard migration techniques.
